(19) United States
(12) Patent Application Publication
(10) Pub. No.: US 2010/0075055 A1
(43) Pub. Date: Mar. 25, 2010

(54) HYDROTHERMAL SYNTHESIS OF ALPHA ALUMINA (a-AL2O3)-BASED FILMS AND COATINGS

(75) Inventor: Wojciech L. Suchanek, Solon, OH (US)

Correspondence Address: PEARNE & GORDON LLP, 1801 EAST 9TH STREET, SUITE 1200, CLEVELAND, OH, 44114-3108, US

(73) Assignee: Sawyer Technical Materials LLC, Eastlake, OH (US)

(21) Appl. No.: 12/554,393

(22) Filed: Sep. 4, 2009

Related U.S. Application Data
(60) Provisional application No. 61/094,137, filed on Sep. 4, 2008.

(51) Int. Cl. B05D 3/02; C01F 7/02; B05C 11/00

(52) U.S. Cl. 427/372.2; 423/625; 118/58; 977/700

(57) ABSTRACT

A process to deposit an Alpha Alumina (α-Al₂O₃) crystalline coating on a substrate surface, wherein the process includes hydrothermal synthesis of the α-Al₂O₃ crystalline coating.

### RELATED APPLICATION

The present application claims benefit of priority from U.S. Provisional Patent Application No. 61/094,137, which is incorporated herein by reference.

### BACKGROUND

Alpha alumina (α-Al₂O₃, corundum) is one of the most widely utilized ceramic materials due to a favorable combination of such properties as high mechanical strength and hardness, good wear resistance, low electric conductivity, high refractoriness, and high corrosion resistance in a broad range of chemical environments. Applications of α-Al₂O₃ include abrasive materials, electric insulators, structural ceramics, vacuum tube envelopes, refractory bricks, liners, and sleeves used in metallurgical applications, kiln furnaces, etc., laboratory ware, catalytic supports, etc.

α-Al₂O₃ has been used in the form of coatings/films for several important applications. In thermal barrier coatings (TBC), the α-Al₂O₃ films act as diffusion and thermal barriers protecting underlying high-temperature alloys from damage in gas turbines and engines. α-Al₂O₃ wear-resistant coatings are applied on metals or cemented carbides to significantly prolong the lifetime of cutting tools. Very high purity alumina coatings can be used as electric insulators in electric/electronic applications. After doping with Cr, Ti, or rare-earth ions, films of α-Al₂O₃ can be used as planar optical waveguides in photonic devices.

Films and coatings of α-Al₂O₃ can be synthesized by several well-established methods, such as sol-gel, chemical vapor deposition (CVD), high-temperature oxidation of Al-containing alloys, PVD techniques, such as pulsed laser deposition, magnetron sputtering, and thermal spray. The later technique actually uses α-Al₂O₃ powders only as feedstock for spraying but due to the high temperature nature of the process, the coatings consist mostly of γ-Al₂O₃ phase with only small content of untransformed α-Al₂O₃ grains. All of the other methods require the use of high temperatures, in order to crystallize the α-Al₂O₃ phase. The synthesis temperatures vary by deposition method and are: 1,100-1,200° C. for sol-gel, 1,000-1,100° C. for CVD, 850-1,050° C. for pulsed laser deposition, and 1,200° C. for high-temperature oxidation. The very high synthesis temperatures lead to several detrimental effects, such as undesired oxidation/corrosion of the substrate metal (for example Inconel 718), formation of very large residual thermoelastic stresses between the coating and the substrate, which can result in cracking, peeling-off of the coatings, or diffusion of metals from the substrate into the coating. Besides, techniques such as CVD or PVD require expensive equipment, use corrosive gases, and thus are expensive and environmentally stressful. Deposition processes using lower temperatures of 280-560° C., such as rf magnetron sputtering, still necessitate using Cr₂O₃ template layer to promote formation of the α-Al₂O₃ phase.

A viable low-temperature, inexpensive, and environmentally benign alternative to the film deposition techniques described above is the hydrothermal method. Hydrothermal synthesis simultaneously deposits and crystallizes anhydrous coatings/films directly from aqueous solutions at low temperatures and under moderate pressures. This technology offers several advantages over conventional film deposition methods, such as one-step synthesis without high temperature calcination, unique chemical defect structure, excellent control of film microstructure, flexibility in substrate shape and size when compared to deposition techniques such as CVD or PVD, simplicity, and low cost. There is no need for expensive equipment (PVD), vacuum systems, or corrosive gases (CVD). The hydrothermal technique allows the direct deposition of crystalline films or coatings using simple aqueous solutions as precursors in simple autoclaves at low temperatures, greatly reducing or eliminating difficulties associated with thermal strain mismatch, film/substrate interdiffusion, films peel-off, and other deleterious effects that occur at high temperatures with other films/coatings deposition methods, particularly those requiring temperatures up to over 1,000° C. All these attributes make the hydrothermal process commercially appealing, particularly for α-Al₂O₃.

No α-Al₂O₃ films or coatings of any type have ever been synthesized by the hydrothermal method on any type of substrates (metallic, ceramic, or polymers).

### SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with various aspects, the present invention provides use of hydrothermal synthesis to prepare a variety of α-Al₂O₃ based coatings on several types of metals (316 stainless steel, 1018 carbon steel, Inconel 718, and Grade 5 Titanium) at low temperature around 400° C. without any template layers. The coatings are either 100% α-Al₂O₃ phase or consist of mixtures of various quantities of the α-Al₂O₃ phase and substrate metal-derived oxides. Their microstructures, i.e. grain size, coating thickness, or surface coverage, can be controlled in wide ranges by changing the synthesis conditions. The hydrothermal synthesis offers here several advantages, such as low synthesis temperature, which minimizes thermal stresses and interdiffusion, good control of the film microstructure and phase composition, uniform coverage on complex shapes, and possibility of coating metals, which are not resistant to high temperatures.

In accordance with one specific aspect, the present invention provides a process to deposit an Alpha Alumina (α-Al₂O₃) crystalline coating on a substrate surface, wherein the process includes hydrothermal synthesis of the α-Al₂O₃ crystalline coating.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a schematic diagram of an example autoclave assembly usable in hydrothermal synthesis of α-Al₂O₃ coatings/films in accordance with an aspect of the present invention;

FIGS. 2A and 2B are charts showing example heating ramps of the hydrothermal synthesis of α-Al₂O₃ coatings/films in accordance with one aspect of the present invention (temperatures, durations, pressures, and chemical reactions are given), with FIG. 2A being for a Dual-ramp heat treatment and FIG. 2B being for a single-ramp heat treatment;

FIGS. 3A-3F are low-magnification SEM photographs revealing uniform coverage of substrate roughness (machining grooves, scratches) by the α-Al₂O₃-based films and showing various aspects in accordance with the present invention deposited under hydrothermal conditions on various substrates, with FIG. 3A showing uncoated 316 stainless steel, FIG. 3B showing coated 316 stainless steel, FIG. 3C showing coated 1018 carbon steel, FIG. 3D showing coated Inconel 718, FIG. 3E showing coated Ti Grade 5, and FIG. 3F showing α-Al₂O₃ grain interlock on a machining groove (Inconel 718 substrate);

FIGS. 4A-4D are SEM photographs revealing typical microstructures of α-Al₂O₃ films in accordance with various aspects of the present invention deposited under hydrothermal conditions on Inconel 718 substrates, with FIGS. 4A and 4B being for Example 1 disclosed herein and FIGS. 4C and 4D being for Example 2 disclosed herein;

FIG. 5 is a graphical plot showing XRD patterns of α-Al₂O₃ films in accordance with various aspects of the present invention deposited under hydrothermal conditions on Inconel 718 substrates, with plot (a) being for uncoated Inconel 718 substrate reference, plot (b) being for Example 1 disclosed herein, plot (c) being for Example 2, and plot (d) being for Example 3;

FIGS. 6A-6F are SEM photographs revealing typical microstructures of α-Al₂O₃ films of the present invention deposited under hydrothermal conditions on 316 stainless steel substrates, with FIGS. 6A and 6B being for Example 4 disclosed herein, FIGS. 6C and 6D being for Example 5 disclosed herein, and FIGS. 6E and 6F being for Example 6 disclosed herein;

FIG. 7 is a graphical plot showing XRD patterns of α-Al₂O₃ films in accordance with various aspects of the present invention deposited under hydrothermal conditions on 316 stainless steel substrates, with plot (a) being for uncoated 316 stainless steel reference, plot (b) being for Example 4 disclosed herein, plot (c) being for Example 5, plot (d) being for Example 6, and plot (e) being for Example 7;

FIGS. 8A and 8B are SEM photographs revealing typical microstructures of α-Al₂O₃ films in accordance with aspects of the present invention deposited under hydrothermal conditions on 1018 carbon steel substrates, and which are for Example 8 disclosed herein;

FIG. 9 is a graphical plot showing XRD patterns of α-Al₂O₃ films in accordance with various aspects of the present invention deposited under hydrothermal conditions on 1018 carbon steel substrates, with plot (a) being for uncoated 1018 carbon steel reference, plot (b) being for Example 8 disclosed herein, plot (c) being for Example 9, and plot (d) being for Example 10;

FIGS. 10A-10F are SEM photographs revealing typical microstructures of α-Al₂O₃ films in accordance with aspects of the present invention deposited under hydrothermal conditions on titanium substrates, with FIGS. 10A-10C being for Example 11 disclosed herein and FIGS. 10D-10F being for Example 12;

FIG. 11 is a graphical plot showing XRD patterns of α-Al₂O₃ films in accordance with various aspects of the present invention deposited under hydrothermal conditions on titanium substrates, with plot (a) being for uncoated titanium grade 5 reference, plot (b) being for Example 11 disclosed herein, plot (c) being for Example 12, and plot (d) being for Example 13;

FIGS. 12A and 12B are stress maps of α-Al₂O₃ films in accordance with aspects of the present invention and associated with deposition under hydrothermal conditions, with FIG. 12A being Example 1 with Inconel 718, and FIG. 12B being for Example 5 with 316 stainless steel and the stress units are GPa and the map size is about 200 μm×200 μm;

FIG. 13 is a graphical plot showing XEDS spectrum of α-Al₂O₃ crystals in α-Al₂O₃ film in accordance with at least one aspect of the present invention deposited under hydrothermal conditions on 316 stainless steel, with the presence of Fe and Cr dopants in addition to Al and O, and with Palladium peaks derived from the conductive coating sputtered prior to the SEM-EDS investigation;

FIG. 14 is a graphical plot showing XEDS spectrum of α-Al₂O₃ crystals in α-Al₂O₃ film in accordance with at least one aspect of the present invention deposited under hydrothermal conditions on Inconel 718, with the presence of Fe, Ni and Cr dopants in addition to Al and O, and with Palladium peaks derived from the conductive coating sputtered prior to the SEM-EDS investigation;

FIG. 15 is a graphical plot showing XEDS spectrum of α-Al₂O₃ crystals in α-Al₂O₃ film in accordance with at least one aspect of the present invention deposited under hydrothermal conditions on titanium, with the presence of Ti dopants in addition to Al and O, and with Palladium peaks derived from the conductive coating sputtered prior to the SEM-EDS investigation; and

FIGS. 16A and 16B are schematic illustrations showing major types of interactions between the substrate and the α-Al₂O₃ films under hydrothermal conditions, in which FIG. 16A is for a reactive substrate, which produces α-Al₂O₃ based composite films, and FIG. 16B is for non-reactive (inert) substrate, which results in the formation of phase-pure α-Al₂O₃ coatings.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

### Experimental Procedure

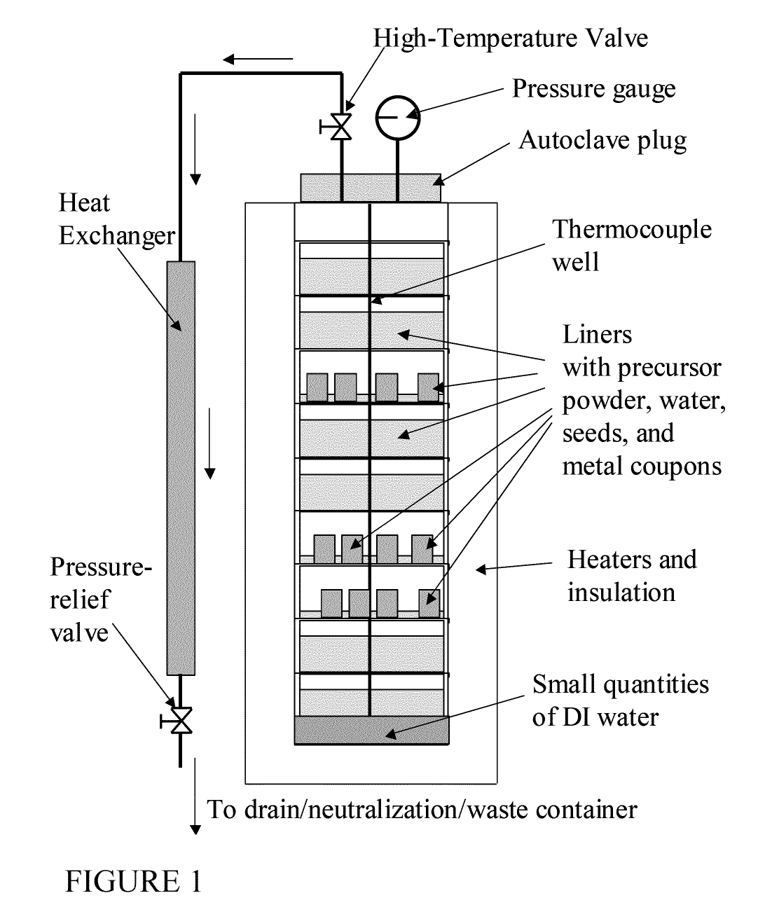

The hydrothermal syntheses of α-Al₂O₃ coatings in the present invention were performed in thoroughly cleaned and hermetically closed with modified Bridgman-type plug steel autoclaves (13″ Diameter×120″ Height, Autoclave Engineers, Erie, Pa.) equipped with two centrally positioned thermocouples, two PID temperature controllers, a pressure gauge, and a pressure relief system designed to vent excess pressure during synthesis and after the synthesis, as well as keeping pressure constant at a desired level (See FIG. 1). Typically, the autoclaves were filled with several custom-made titanium liners (12″ Diameter×11″ Height), covered with lids, and stacked one on another as demonstrated in FIG. 1. In some cases, several smaller titanium liners (2″ Diameter×4″ Height) were placed inside the 12″ Diameter liners, with some DI water present on the bottom of each 12″ Diameter liner. The liners were used to control contamination of the products and/or protect the autoclave from chemical attack. Both the interior and the exterior of each liner, including new and older (re-used) liners, were carefully cleaned to remove any contamination and loose alumina powders. The load in each liner could be the same or could be different than in the other liners, which allowed synthesis of various types of α-Al₂O₃ coatings and on various substrates with various sizes within the same autoclave under the same temperature, pressure, duration, heating and cooling routines. The liners were positioned on special supports, which allowed simultaneous loading/unloading of 1-10 large liners (FIG. 1). The bottom of the autoclave was filled with DI water (below the liners), to generate initial pressure in the autoclave during the hydrothermal synthesis (FIG. 1). The amount of water varied and depends upon total water content in the autoclave (calculated as a sum of water in the liners and water from decomposition of the precursors).

### Hydrothermal Synthesis of α-Al₂O₃Based Coatings

Coatings/films that contained either 100% α-Al₂O₃ phase or coatings/films consisting of various mixtures of α-Al₂O₃ phase with substrate-derived metal oxides, with various microstructures and levels of substrate coverage were synthesized in the present invention using the following procedure. First, appropriate weight of de-ionized water was added to HDPE containers or titanium liners. Then, desired weights of chemical additives, if any, were added to the containers, and the containers were stirred thoroughly in order to obtain homogeneous solutions. Then, appropriate weights of the precursor powder (Type A or Type B, see Table I for detailed descriptions) were added to each of the containers and stirred thoroughly to obtain uniform slurry. Finally, the seeds, if any, were added and content of the containers was stirred again for 1-2 minutes in order to disperse the seeds uniformly in the slurry.

TABLE I
Physicochemical properties of selected precursor powders
used for hydrothermal synthesis of α-Al₂O₃ coatings/films

| | Precursor | Precursor |
|---|---|---|
| Property | Type A | Type B |
| Al₂O₃ (%) | 65.0 | 65.0 |
| Total Na₂O (%) | 0.1 | 0.35 |
| Soluble Na₂O (%) | 0.01 | 0.009-0.048 |
| | | (max. 0.17) |
| Fe₂O₃ (%) | 0.01 | 0.007 |
| SiO₂ (%) | 0.005 | 0.001 |
| Free Moisture (%) | 0.05 | 0.2-0.3 |
| | | (max. 0.7) |
| Specific Gravity (g/cm³) | 2.42 | 2.42 |
| Refractive Index (—) | 1.57 | 1.57 |
| Grit +325 mesh (%) | 10-30 | 0.01 |
| Median Particle Size (μm) | 25 (average) | 0.47 |
| Specific Surface Area (m²/g) | — | 12-15 |

If the slurry was prepared in a titanium liner, coupons of metals to be coated where subsequently placed in the bottom part of each liner, so they were completely covered by the precursor slurry. Alternately, if the slurry was prepared in separate HDPE container, the metal coupons were first placed in the bottom of empty titanium liners and then the precursor slurry was poured in, to obtain complete coverage of the coupons. The following metal coupons with sizes ½″×½″×0.125″ (all obtained from Metal Samples Company, Munford, Ala.) were used: Inconel 718 (chemical analysis Al=0.480%, Cr=18.320%, Mo=2.990%, S=0.0002%, B=0.004%, Cu=0.060%, Nb=5.190%, Si=0.080%, C=0.030%, Fe=18.020%, Ni=53.650%, Ta=0.010%, Co=0.100%, Mn=0.080%, P=0.008%, and Ti=0.980%), stainless steel 316 (Cr=16.793%, Mo=2.206%, S=0.001%, Cu=0.308%, N=0.041%, Si=0.225%, C=0.023%, Ni=10.025%, Mn=1.567%, P=0.029%, and Fe=balance), carbon steel 1018 (S=0.007%, Si=0.020%, C=0.160%, Mn=0.750%, P=0.010%, Al=0.050%, and Fe=balance), and titanium grade 5 (C=0.030%, Al=6.150%, N=0.020%, Y<50 ppm, 0=0.170%, Fe=0.150%, H=48 ppm, V=3.930%, and Ti=balance).

Smaller titanium liners were placed inside large 12″ Diameter titanium liners, which were then closed with lids, placed in a special steel holder (up to 5 containers per holder), and put into the autoclave as described earlier. Detailed concentrations and types of used precursors, seeds, chemical additives, and dopants are summarized in Table II.

TABLE II

| | | | | Temperature and | | | |
|---|---|---|---|---|---|---|---|
| | | | | pressure | Phase | | |
| | Type and | | Type and | conditions of | composition of | | |
| | weight of | Weight of | weight of | the hydrothermal | the coatings | Thickness/ | Surface |
| | the precursor | the DI water | the seeds | synthesis | by XRD | grain size | coverage |
| Example | | | | | | | |
| No. | | | | | | | |

Summary of the synthesis conditions of various α-Al₂O₃ coatings on Inconel 718 (examples only).

| | | | | | | | |
|---|---|---|---|---|---|---|---|
| Example 1 | Type A | 150 g | 30 g | Ramp 2 heating | α-Al₂O₃ | 3-5 μm | Continuous film, |
| | 300 g | | (10 wt %) 1 μm | rate = 23.3° C./hr | | thick, 1- | dense |
| | | | α-Al₂O₃ | Tmax = 430° C. (7 | | 3 μm grain | microstructure |
| | | | | days), 2,000 psi at | | size | |
| | | | | Tmax | | (equiaxed) | |
| Example 2 | Type A | 150 g | None | Single ramp: heating | α-Al₂O₃ | ~20 μm | Partial coverage- |
| | 300 g | | | rate = 11.7° C./hr | | thick, 20- | islands only, |
| | | | | Tmax = 380° C. (5 | | 30 μm grain | preferred |
| | | | | days), 2,000 psi at | | size | nucleation on |
| | | | | Tmax | | (equiaxed) | machining |
| | | | | | | | grooves/scratches |
| Example 3 | Type A | 150 g | None | Ramp 2 heating | α-Al₂O₃ + γ- | N/A | N/A |
| | 300 g | | | rate = 23.3° C./hr | AlOOH | | |
| | | | | Tmax = 380° C. (7 | (boehmite) | | |
| | | | | days), 2,000 psi at | | | |
| | | | | Tmax | | | |
| Substrate | | | | | | | |
| metal | | | | | | | |

Summary of the synthesis conditions of various α-Al₂O₃ coatings on stainless steel 316 (examples only).

| | | | | | | | |
|---|---|---|---|---|---|---|---|
| Example 4 | Type A | 150 g | None | Ramp 2 heating | α-Al₂O₃ + | ~20 μm | Continuous, |
| | 300 g | | | rate = 23.3° C./hr | Fe₂O₃ | thick, 10- | uniform film, not |
| | | | | Tmax = 430° C. (7 | (hematite) | 30 μm grain | dense |
| | | | | days), 2,000 psi at | | size | microstructure |
| | | | | Tmax | | (plateles) | |
| Example 5 | Type A | 150 g | 30 g | Ramp 2 heating | α-Al₂O₃ + | 3-5 μm | Continuous, |
| | 300 g | | (10 wt %) 1 μm | rate = 23.3° C./hr | Fe₂O₃ | thick, 1- | uniform film, |
| | | | α-Al₂O₃ | Tmax = 430° C. (7 | (hematite) | 3 μm grain | dense |
| | | | | days), 2,000 psi at | | size | microstructure |
| | | | | Tmax | | (equiaxed) | |
| Example 6 | Type A | 150 g | 30 g | Single ramp: heating | Fe₂O₃ | 1-2 μm | Continuous, |
| | 300 g | | (10 wt %) 1 μm | rate = 11.7° C./hr | (hematite) + | equiaxed | uniform film, |
| | | | α-Al₂O₃ | Tmax = 380° C. (5 | α-Al₂O₃ | grains of α-Al₂O₃, | dense |
| | | | | days), 2,000 psi at | | 5-10 μm Fe₂O₃ | microstructure |
| | | | | Tmax | | grains (platy) | |
| Example 7 | Type A | 150 g | None | Ramp 2 heating | α-Al₂O₃ + γ- | N/A | N/A |
| | 300 g | | | rate = 23.3° C./hr | AlOOH | | |
| | | | | Tmax = 380° C. (7 | (boehmite) + | | |
| | | | | days), 2,000 psi at | Fe₂O₃ | | |
| | | | | Tmax | (hematite) | | |

Summary of the synthesis conditions of various α-Al₂O₃ coatings on carbon steel 1018 (examples only).

| | | | | | | | |
|---|---|---|---|---|---|---|---|
| Example 8 | Type A | 150 g | None | Single ramp: heating | α-Al₂O₃ + | 5-10 μm | Continuous, |
| | 300 g | | | rate = 11.7° C./hr | Fe₂O₃ | equiaxed | uniform film, |
| | | | | Tmax = 380° C. (5 | (hematite) + | grains of α-Al₂O₃, | dense |
| | | | | days), 2,000 psi at | Fe₃O₄ | embedded in | microstructure |
| | | | | Tmax | (magnetite) | FeₓO_{y} matrix | |
| Example 9 | Type A | 150 g | 30 g | Single ramp: heating | α-Al₂O₃ + | N/A | N/A |
| | 300 g | | (10 wt %) 1 μm | rate = 11.7° C./hr | Fe₂O₃ | | |
| | | | α-Al₂O₃ | Tmax = 380° C. (5 | (hematite) + | | |
| | | | | days), 2,000 psi at | Fe₃O₄ | | |
| | | | | Tmax | (magnetite) | | |
| Example 10 | Type A | 150 g | None | Ramp 2 heating | α-Al₂O₃ + | N/A | N/A |
| | 300 g | | | rate = 23.3° C./hr | Fe₂O₃ | | |
| | | | | Tmax = 380° C. (7 | (hematite) + | | |
| | | | | days), 2,000 psi at | Fe₃O₄ | | |
| | | | | Tmax | (magnetite) | | |

Summary of the synthesis conditions of various α-Al₂O₃ coatings on titanium grade 5 (examples only).

| | | | | | | | |
|---|---|---|---|---|---|---|---|
| Example 11 | Type A | 150 g | None | Single ramp: | α-Al₂O₃ + | 1-3 μm | Continuous, |
| | 300 g | | | heating | Na_{1.97}Al_{1.82}Ti_{6.15}O₁₆ | aggregated | uniform film, |
| | | | | rate = 11.7° C./hr | | grains of α-Al₂O₃ | not dense |
| | | | | Tmax = 380° C. (5 | | (equiaxed), 1-10 μm | microstructure |
| | | | | days), 2,000 psi at | | Na_{1.97}Al_{1.82}Ti_{6.15}O₁₆ | (porous) |
| | | | | Tmax | | grains (lath-like) | |
| Example 12 | Type A | 150 g | None | Ramp 2 heating | α-Al₂O₃ + | 30 μm platy | Continuous, |
| | 300 g | | | rate = 23.3° C./hr | Na_{1.97}Al_{1.82}Ti_{6.15}O₁₆ | grains of α-Al₂O₃, | uniform film, |
| | | | | Tmax = 430° C. (7 | | 1-5 μm | not dense |
| | | | | days), 2,000 psi at | | Na_{1.97}Al_{1.82}Ti_{6.15}O₁₆ | microstructure |
| | | | | Tmax | | grains (platelets) | (porous) |
| Example 13 | Type A | 150 g | None | Ramp 2 heating | γ-AlOOH | N/A | N/A |
| | 300 g | | | rate = 23.3° C./hr | (boehmite) + | | |
| | | | | Tmax = 380° C. (7 | Na_{1.97}Al_{1.82}Ti_{6.15}O₁₆ | | |
| | | | | days), 2,000 psi at | | | |
| | | | | Tmax | | | |

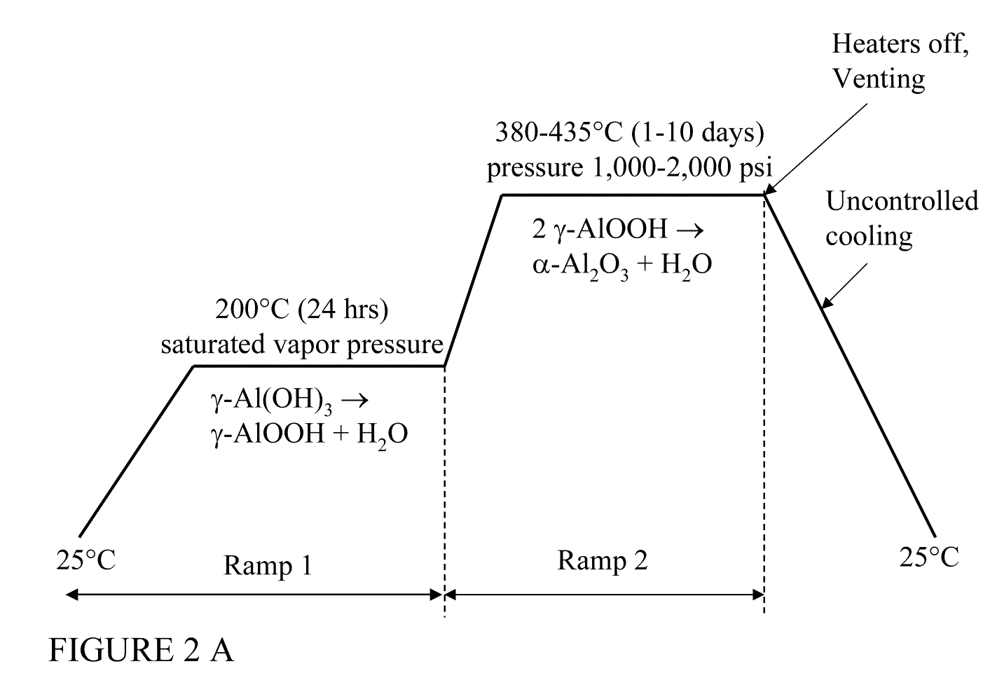

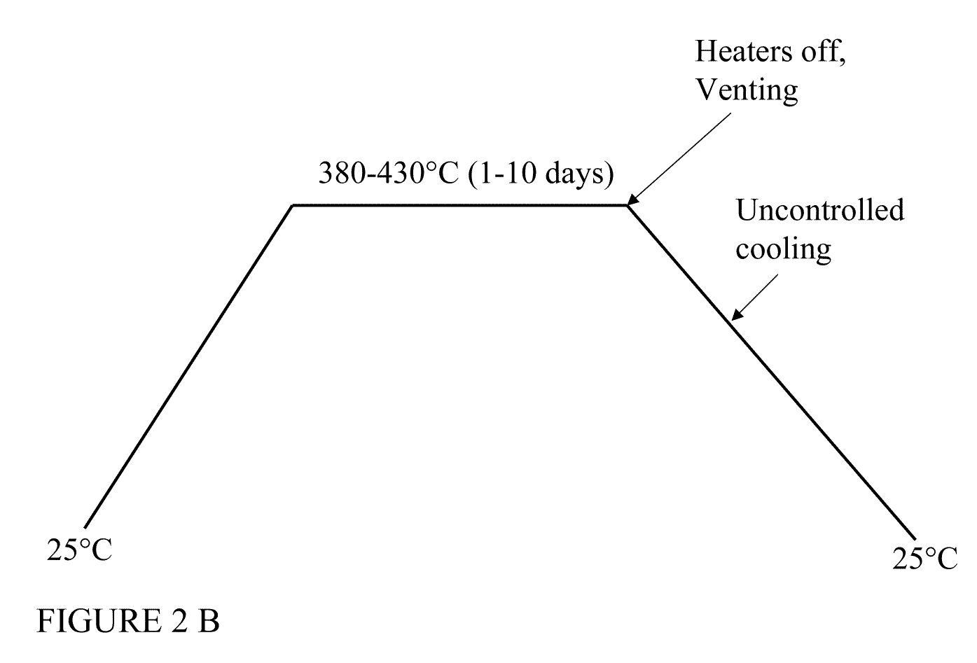

The subsequent hydrothermal treatments in accordance with aspects of the present invention were accomplished in either single-ramp or in dual-ramp regime (see FIGS. 2A and 2B). The dual-ramp heat treatment of the hydrothermal synthesis of α-Al₂O₃ coatings was as follows (see FIG. 2A): Ramp 1: from room temperature to 200° C. with a heating rate of 11.7° C./hr, followed by holding at 200° C. for 24 hours with temperature stability of a few ° C., with pressure being equal to the saturated vapor pressure of water at this temperature; Ramp 2: 200° C.—Maximum Temperature (Tmax) with a heating rate of 9.0-23.3° C./hr, followed by holding at Maximum Temperature for between 1 and 10 days, with temperature stability of a few ° C., with pressure ranging between 1,000 psi and 2,500 psi. The Maximum Temperature is between 380° C. and 430° C. The single-ramp heat treatment of the hydrothermal synthesis of α-Al₂O₃ coatings was as follows (FIG. 2B): single ramp from room temperature to Maximum Temperature with heating rate of 9.0-11.7° C./hr, followed by holding at Maximum Temperature for 1-10 days, with temperature stability of a few ° C., with pressure between 1,000 and 2,500 psi. The Maximum Temperature was 380-430° C. After completing the hydrothermal heat treatment cycle, the autoclave was either naturally cooled down to room temperature, with subsequent drying of the synthesized powders in an oven above 100° C., or the autoclave was vented while still at high temperature, which removes impurities and dries the powders as well.

### Materials Characterization

Phase compositions of metal coupons, both as-received (i.e. untreated) and after hydrothermal treatment with deposited coatings, were characterized by X-ray diffraction using Advanced Diffraction System X1 diffractometer (XRD, Scintag Inc.) using Cu K_{α} radiation, in the 20 range between 20-70° with a 0.05° step size and 1.0 s count time. The chemical identity of the materials was determined by comparing the experimental XRD patterns to standards compiled by the Joint Committee on Powder Diffraction and Standards (JCPDS), i.e. card #10-0173 for α-Al₂O₃ (corundum), #03-0066 for γ-AlOOH (boehmite), #33-0664 for Fe₂O₃ (hematite), #19-0629 for Fe₃O₄ (magnetite), and #80-1012 for Na_{1.97}Al_{1.82}Ti_{6.15}O₁₆.

The microstructures of the metal coupons before and after hydrothermal treatment were examined using both optical microscope (Vanox, Olympus, Tokyo, Japan) under 50-500× magnifications and scanning electron microscope (SEM, Model S-4500, Hitachi, Japan) at 5 kV accelerating voltage. Prior to the SEM examination, the materials were attached to aluminum holders using a conductive carbon tape and subsequently sputtered with thin conductive layers of palladium. Chemical compositions of various regions of the coatings formed on metal coupons during the hydrothermal treatment were determined using Noran X-ray energy-dispersive spectrometry (XEDS) detector attached to the SEM. During the XEDS measurements, 20 kV accelerating voltage was used and the data was accumulated over 60-180 seconds.

Morphology of α-Al₂O₃ coatings, surface roughness, and residual thermoelastic stresses present in the α-Al₂O₃ coatings were measured using laser scanning confocal microscope Olympus FV1000, connected to a high-resolution spectrometer, which allows stress measurements from wavelength shift of the 694 nm fluorescence line of Cr³⁺ ions present in the α-Al₂O₃ lattice.

### Results and Discussion

Typical properties of the α-Al₂O₃-based coatings in accordance with various aspects of the present invention, which were deposited on all types of metal substrates using the hydrothermal method, are summarized in Tables II A-D. It is apparent that the properties of the films, such as phase composition, microstructure, grain size and shape, and film thickness are strong functions of all synthesis parameters, such as temperatures/durations of the hydrothermal treatment, precursor composition, type of the metal substrate, etc. Thus, the selection of appropriate precursors, seeds, dopants (if any), and chemical additives for the hydrothermal synthesis of α-Al₂O₃ coatings is part of the process to obtain product coatings with desired properties as per the requirements of the user.

### Uniformity of the α-Al₂O₃-Based Coatings

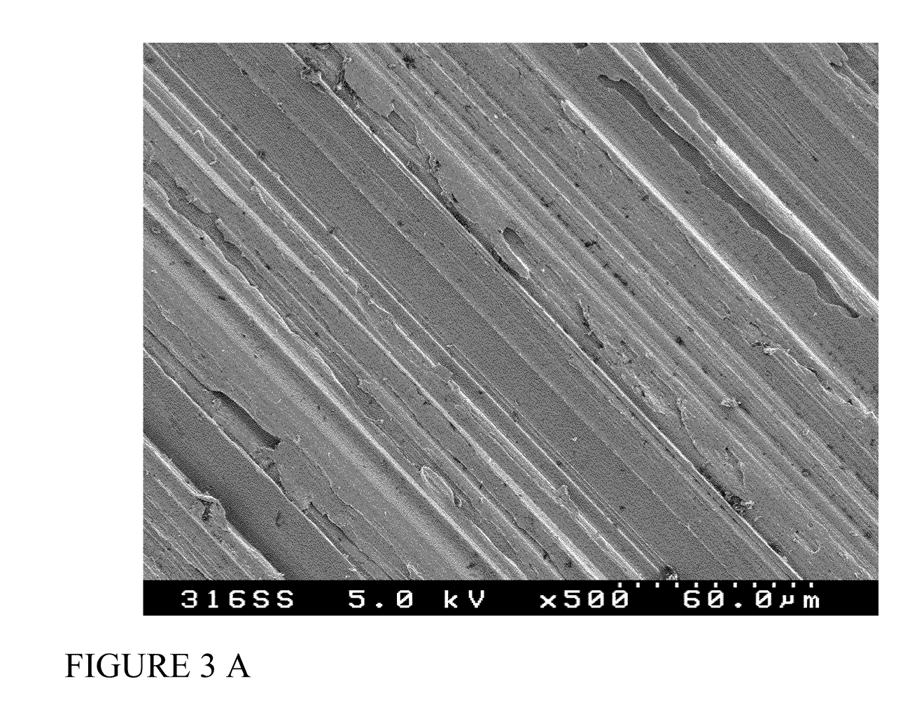

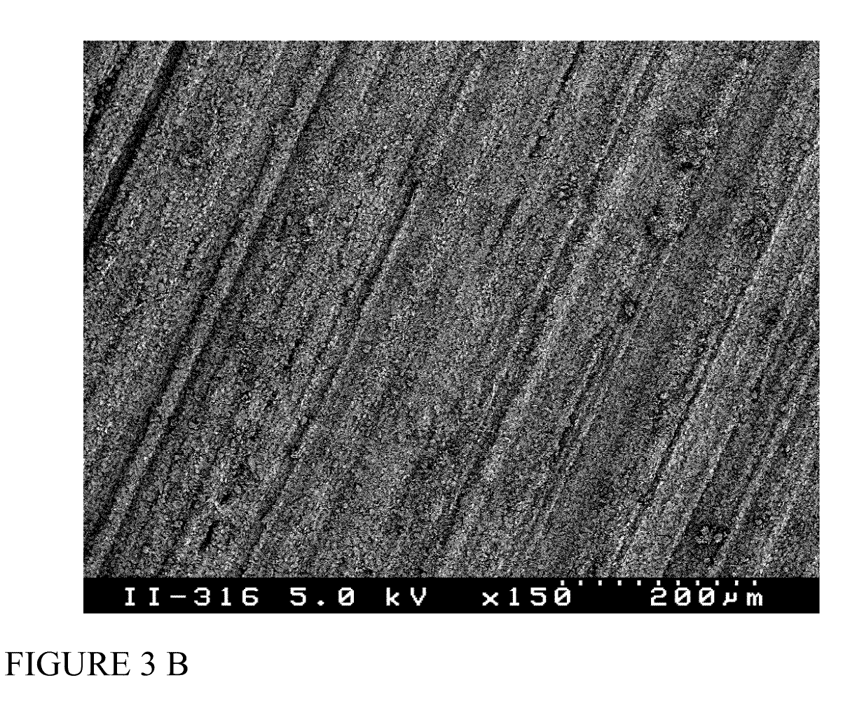

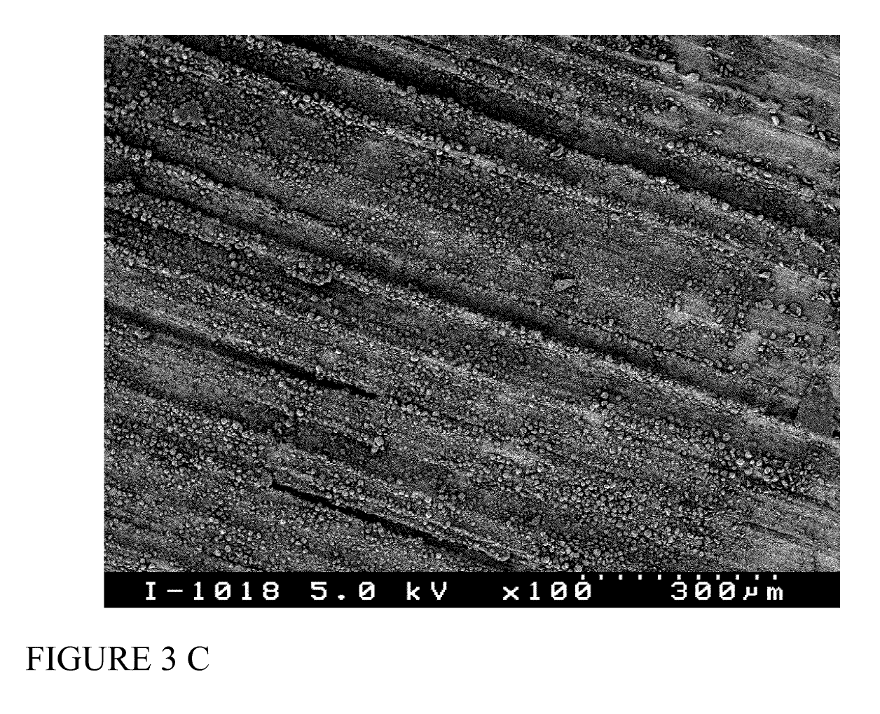

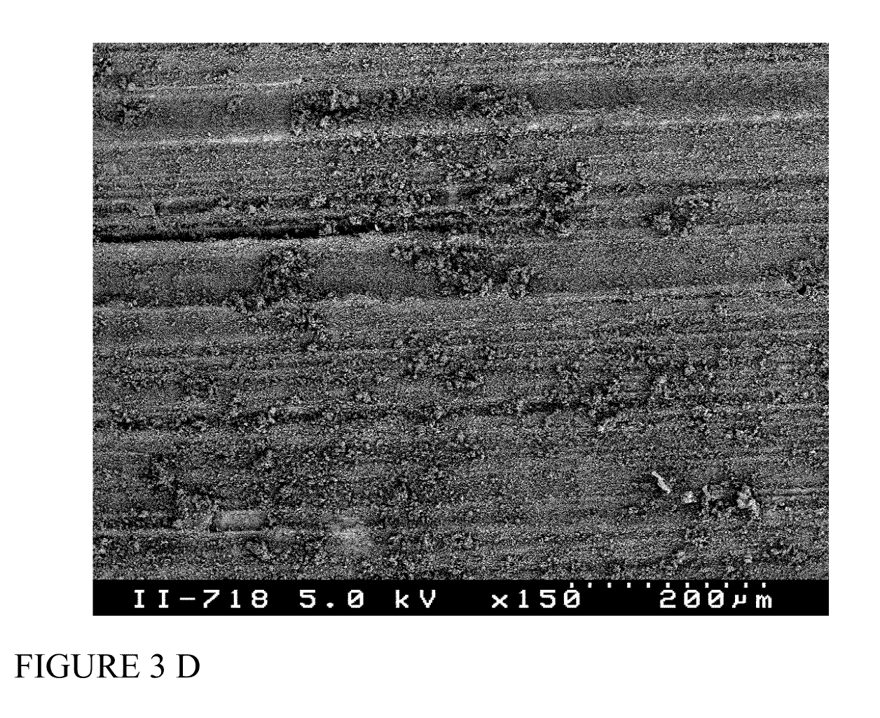

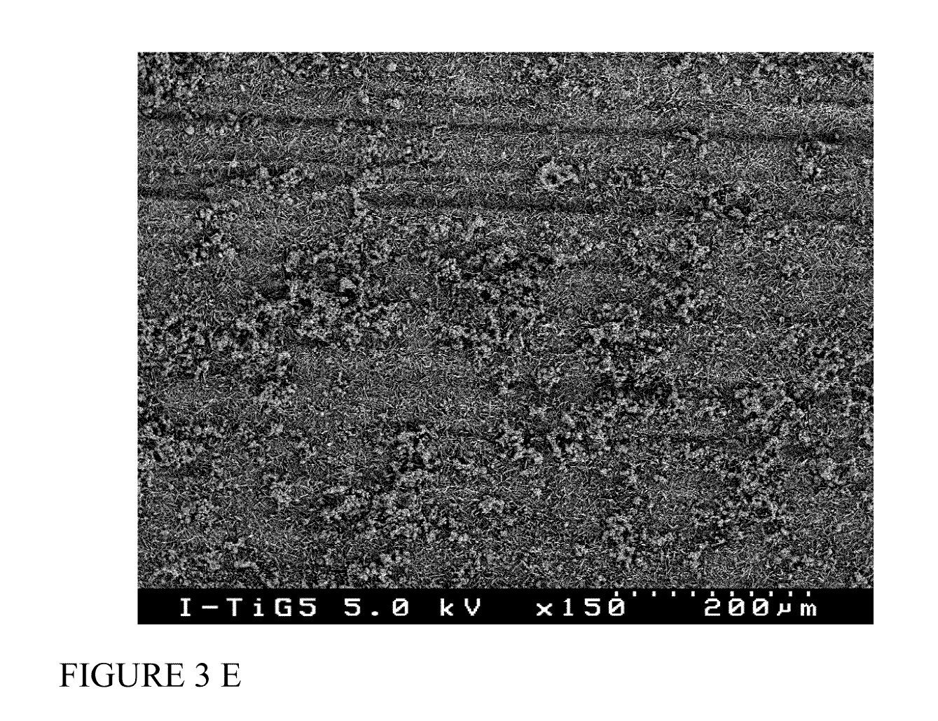

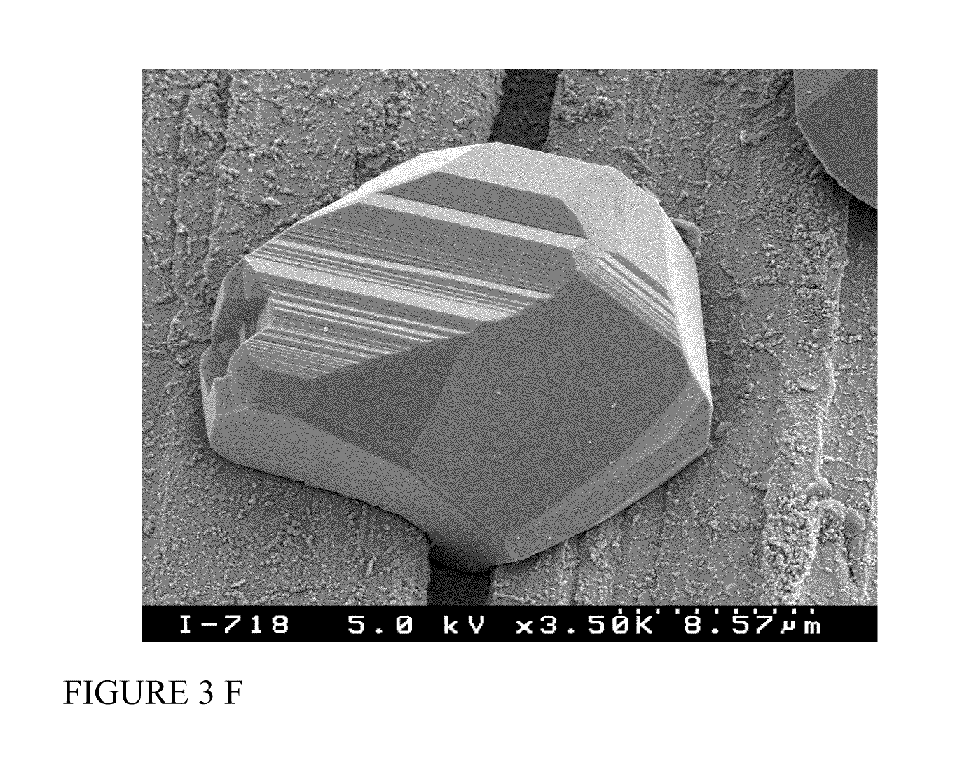

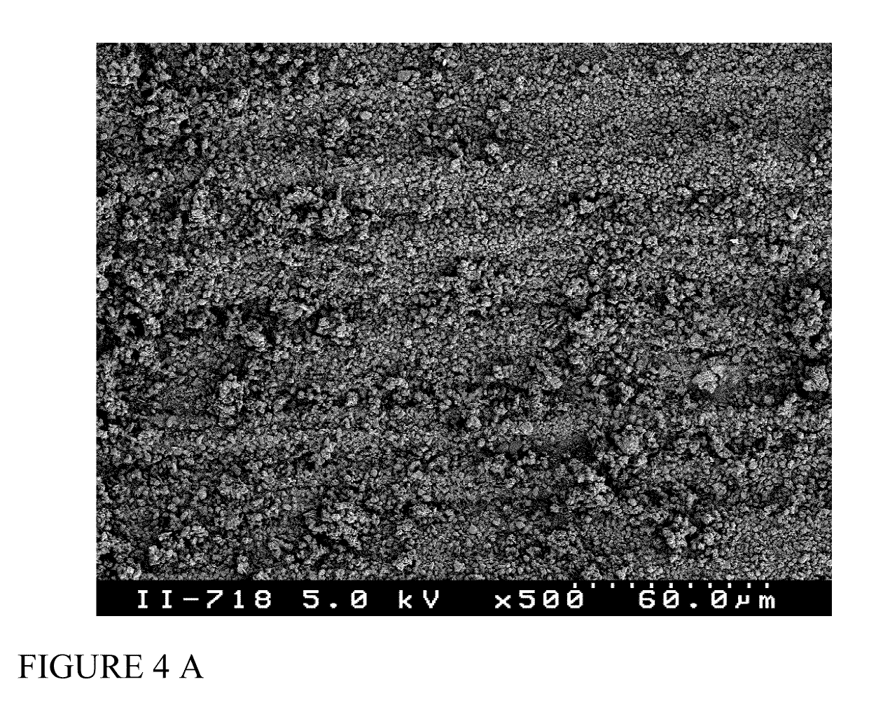

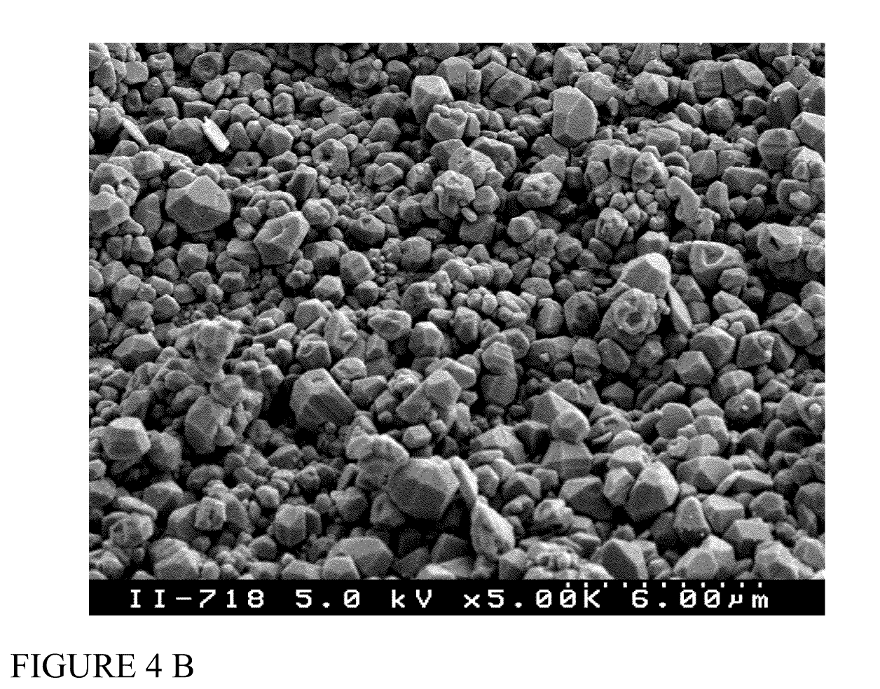

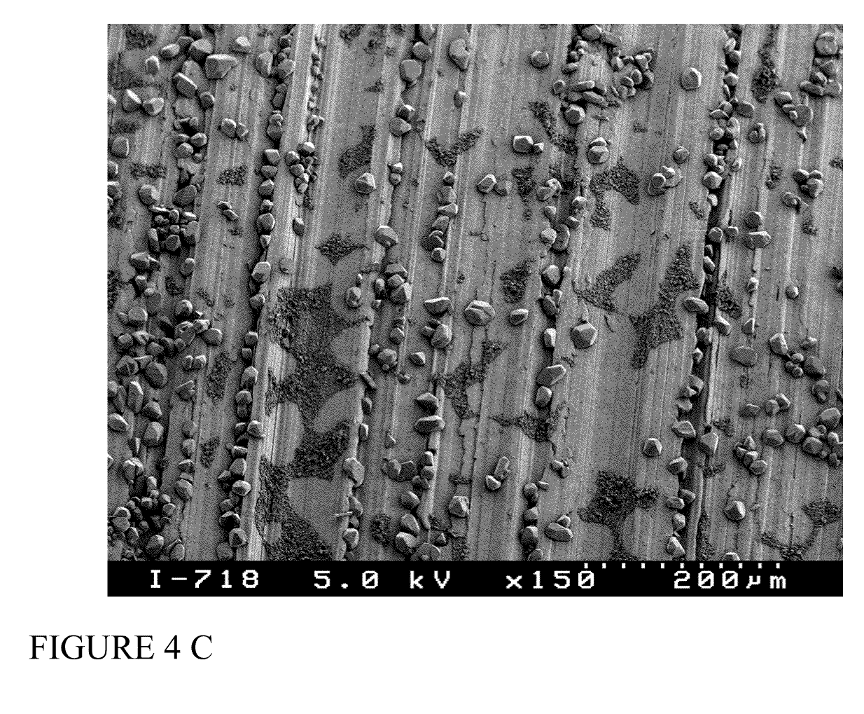

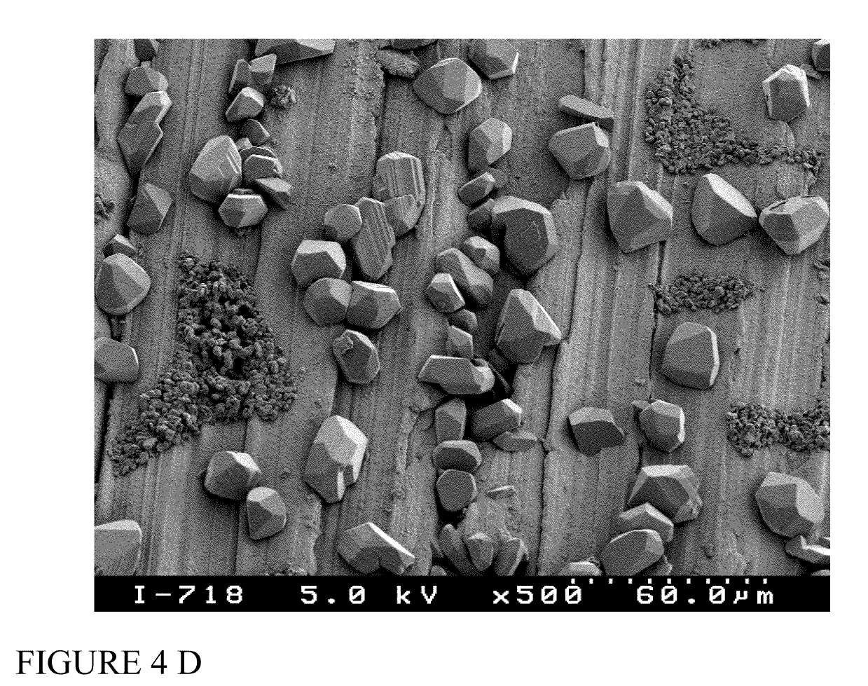

The α-Al₂O₃-based coatings in accordance with various aspects of the present invention cover uniformly all types of metal substrates. The uncoated (as-received) metal substrate coupons were covered with machining groves/scratches (see FIG. 3A). After the hydrothermal process, the deposited α-Al₂O₃-based films coated the metal substrate so uniformly that all substrate-derived groves/scratches were still clearly visible (See FIGS. 3B-3E). The α-Al₂O₃ crystals (islands), which constituted the coatings, had tendency to nucleate on these substrate inhomogenities (see FIGS. 3F and 4C), which are known to provide energetically favorable nucleation sites for heterogeneous nucleation. Thus the hydrothermal synthesis of α-Al₂O₃-based coatings in accordance with the various aspects of the present invention is well suited for coating inhomogeneous/non-flat surfaces, complex shapes, grooves, holes, etc, which is not possible for most of the other film deposition methods.

### Microstructures of the α-Al₂O₃-Based Coatings

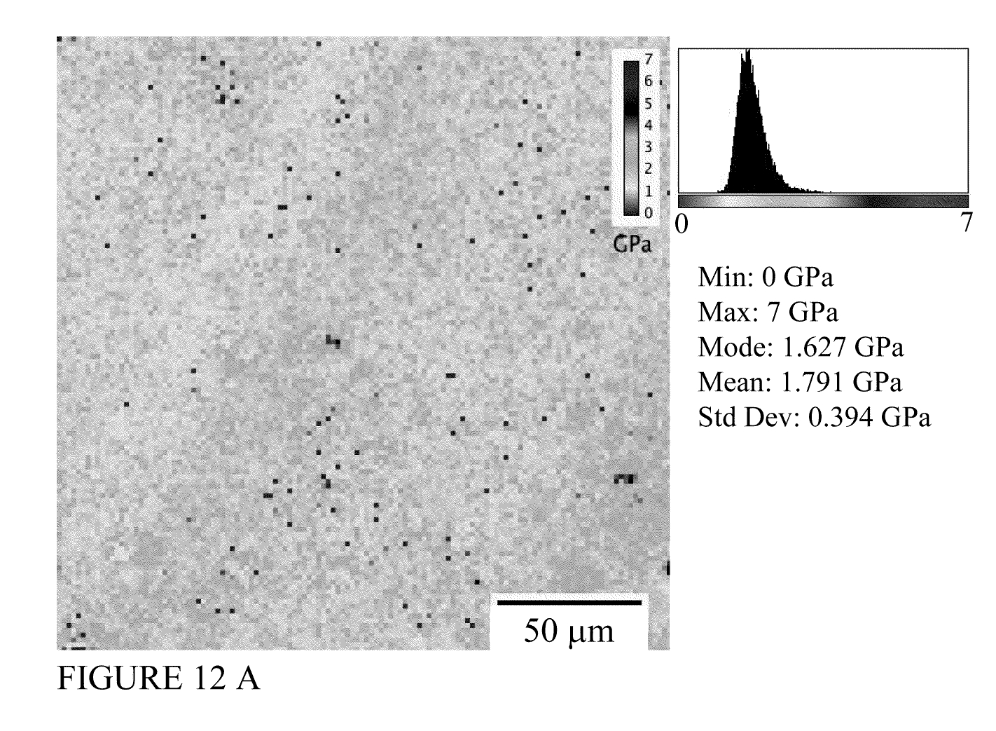

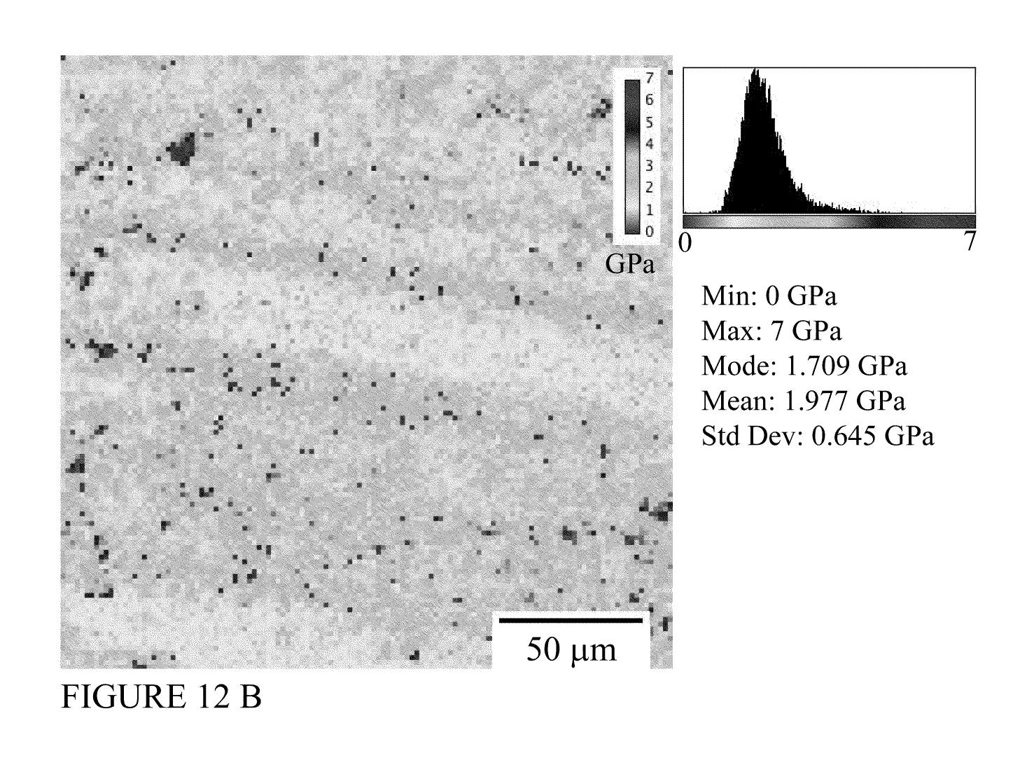

The surface adhesion of the films in accordance with aspects of the present invention was good. No cracks or peeled-off layers were typically observed. This can be attributed to such factors as low deposition temperature thus low residual stresses (see FIGS. 12A and 12B), low thickness of the films, and grain interlock in surface cracks (see FIG. 3F).

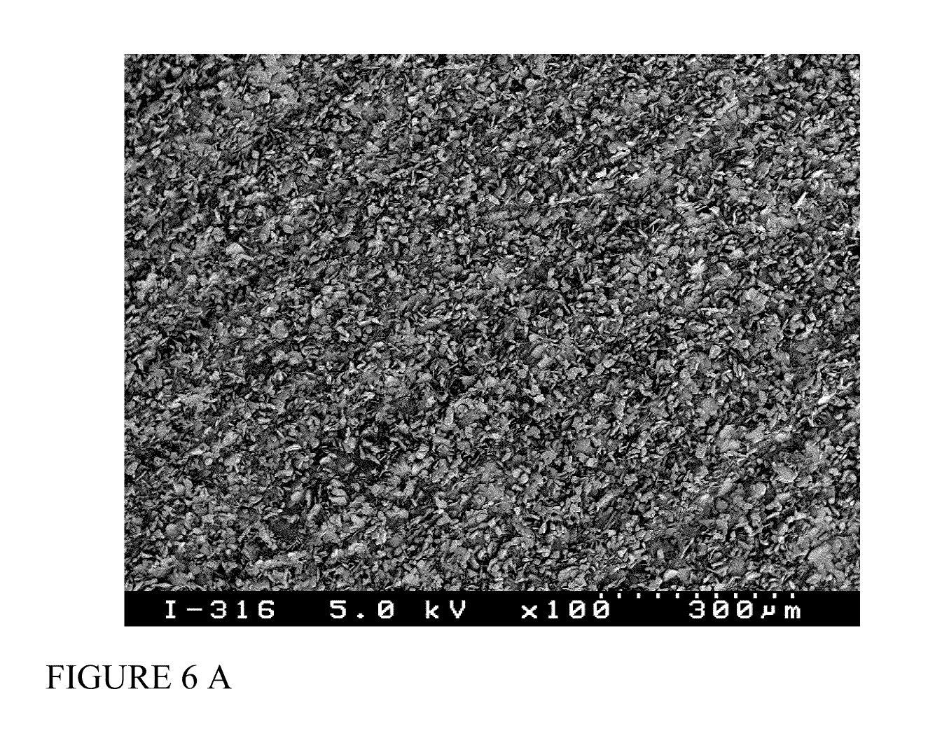

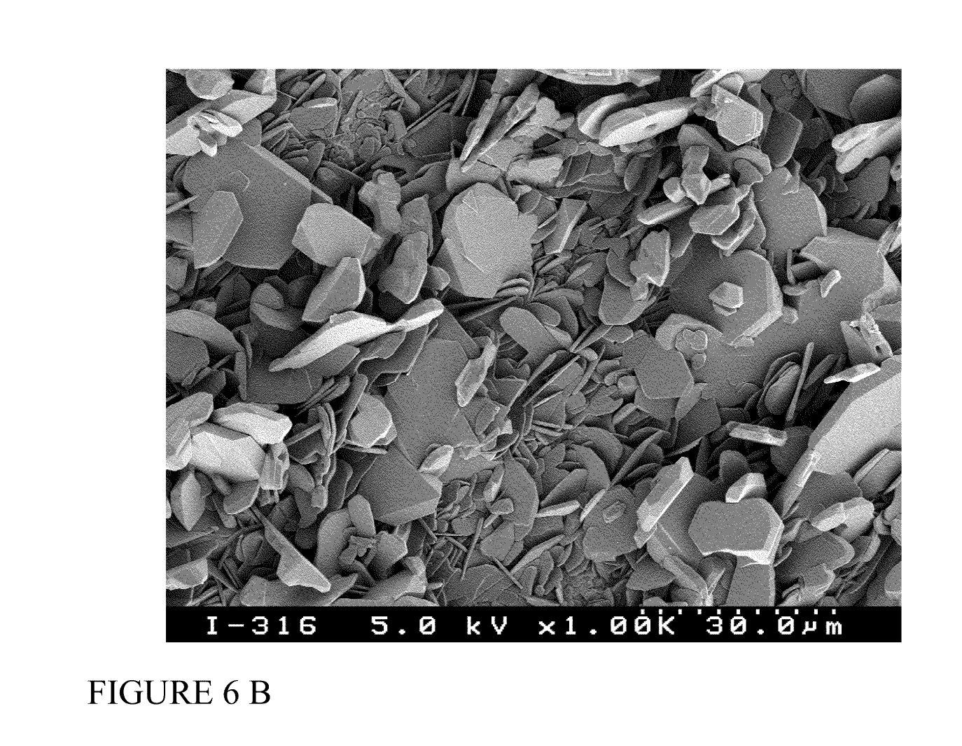

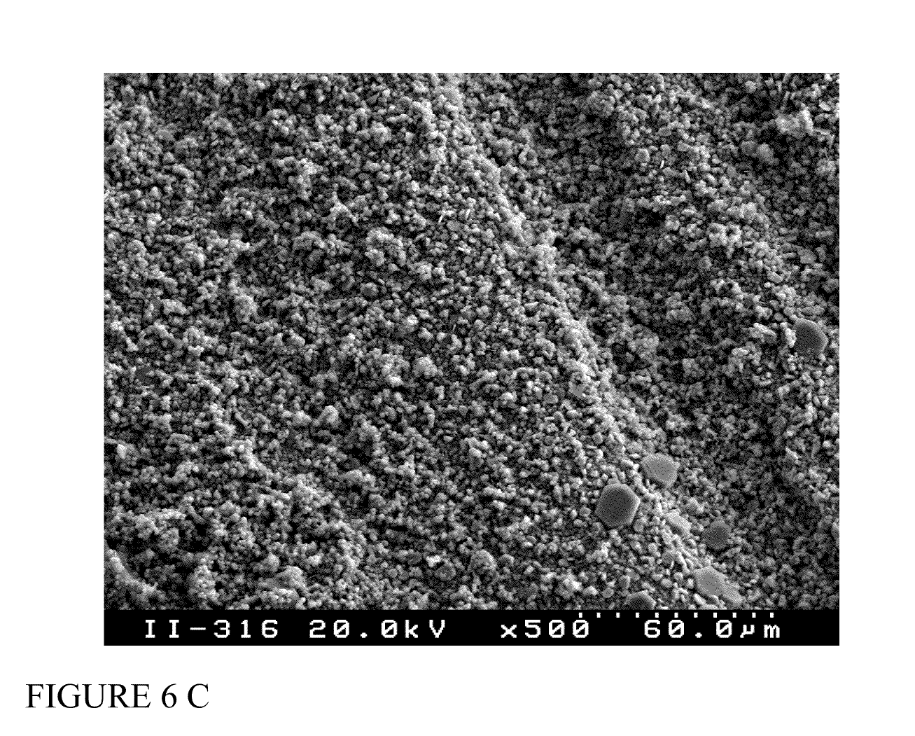

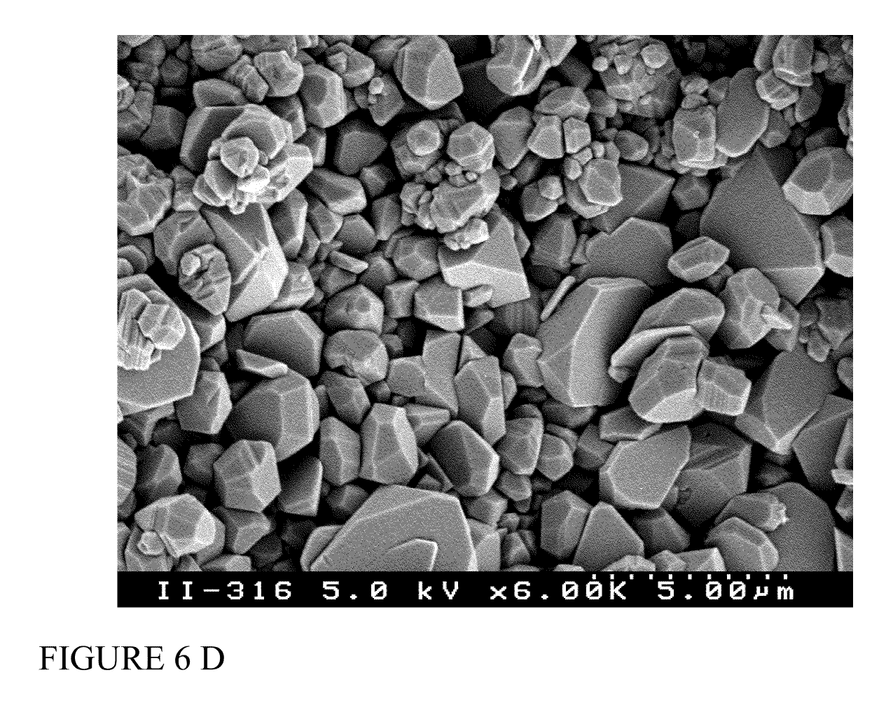

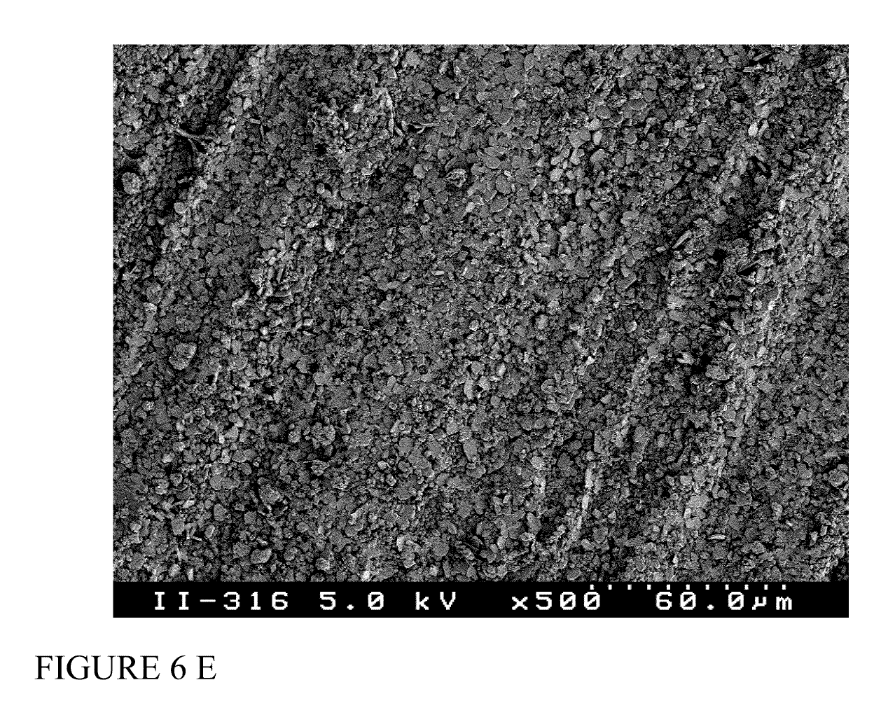

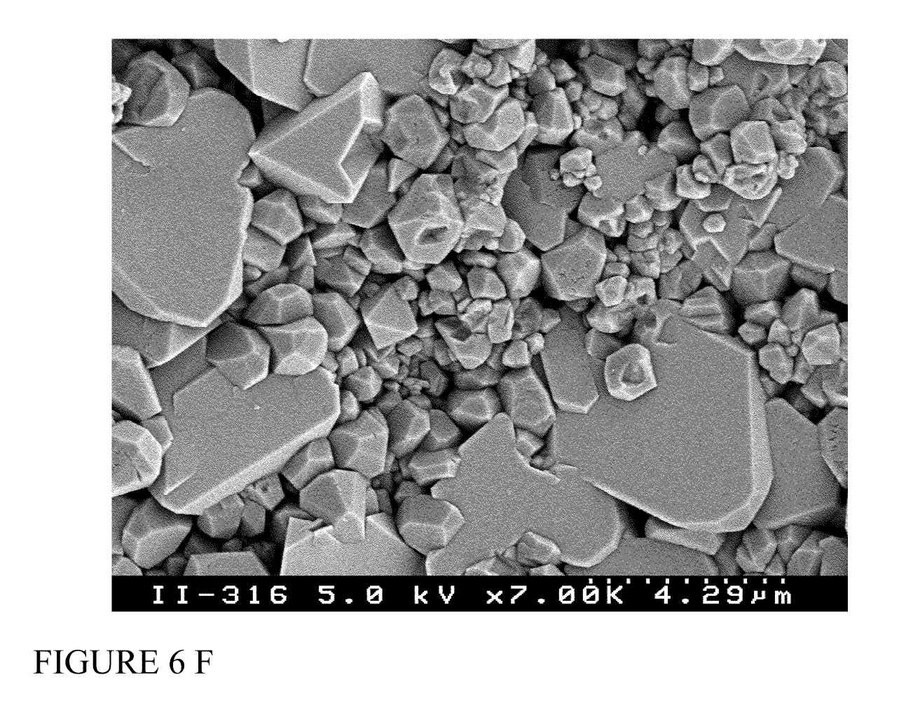

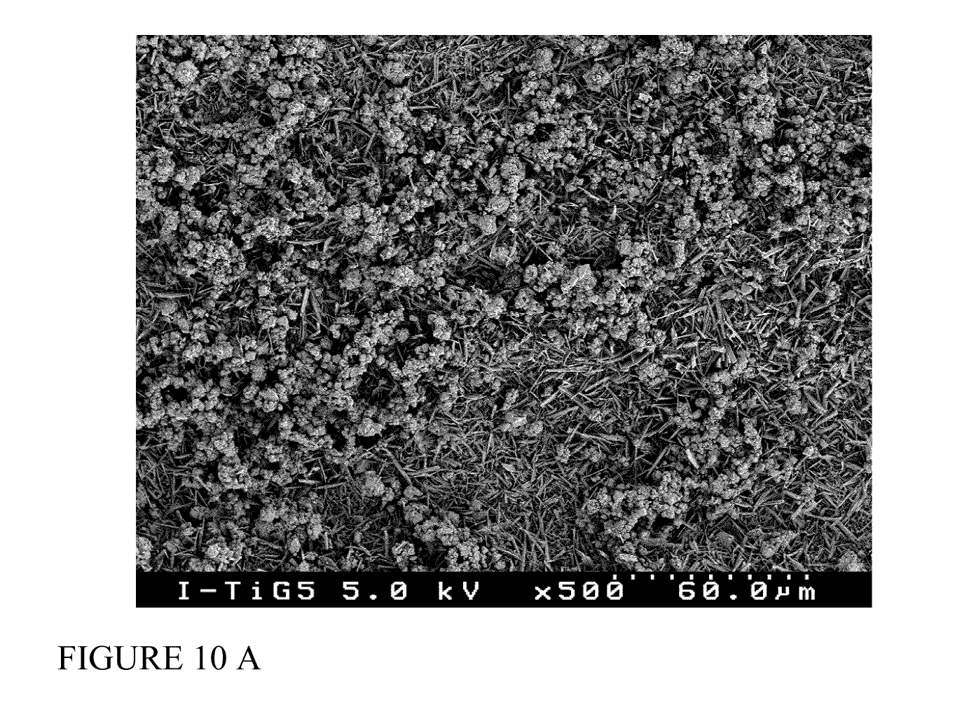

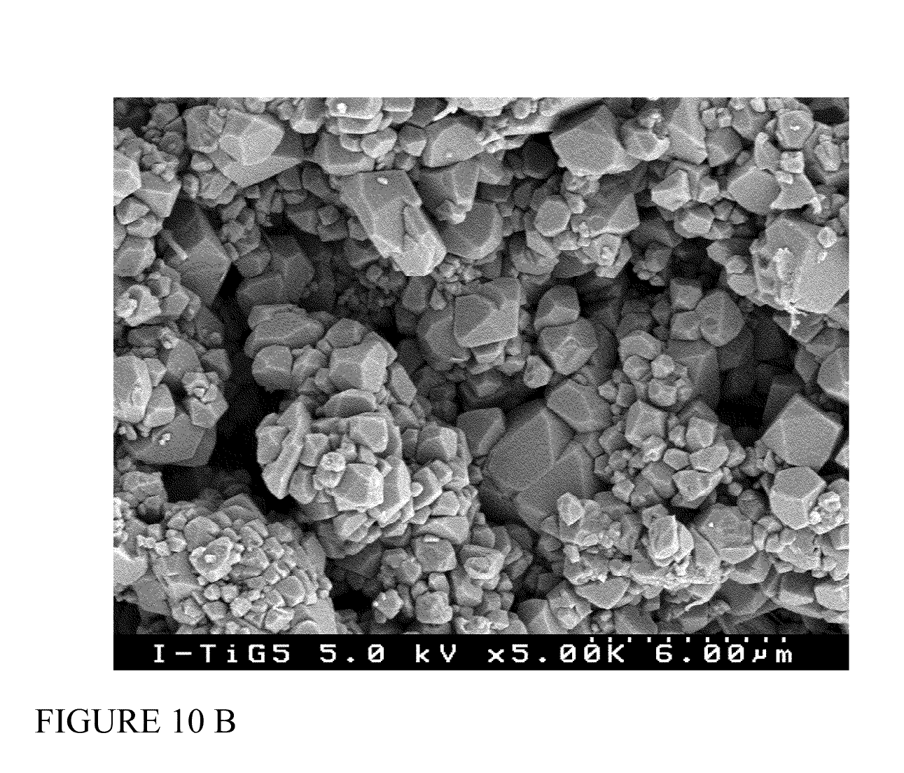

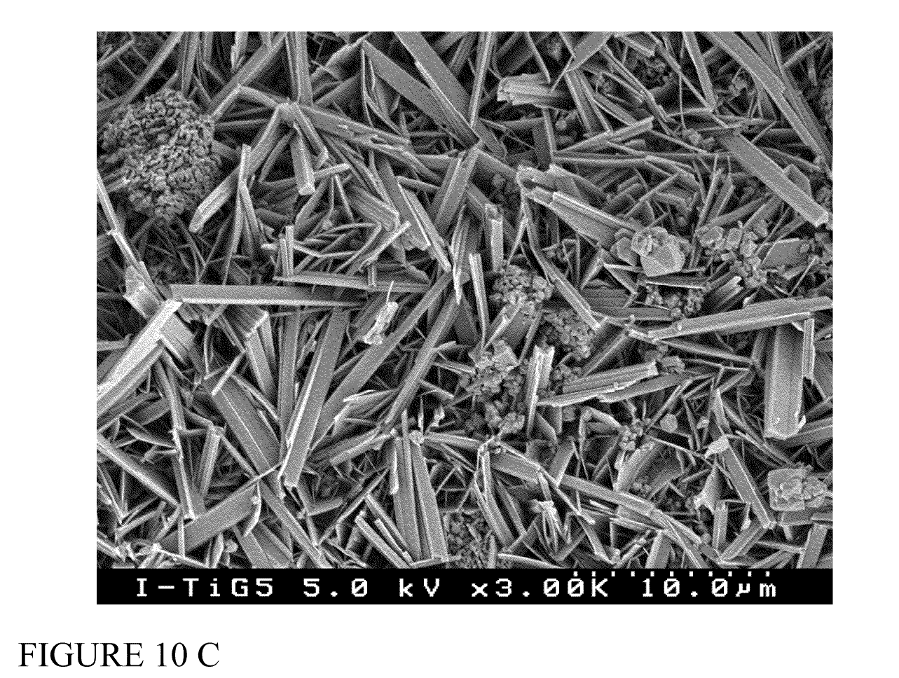

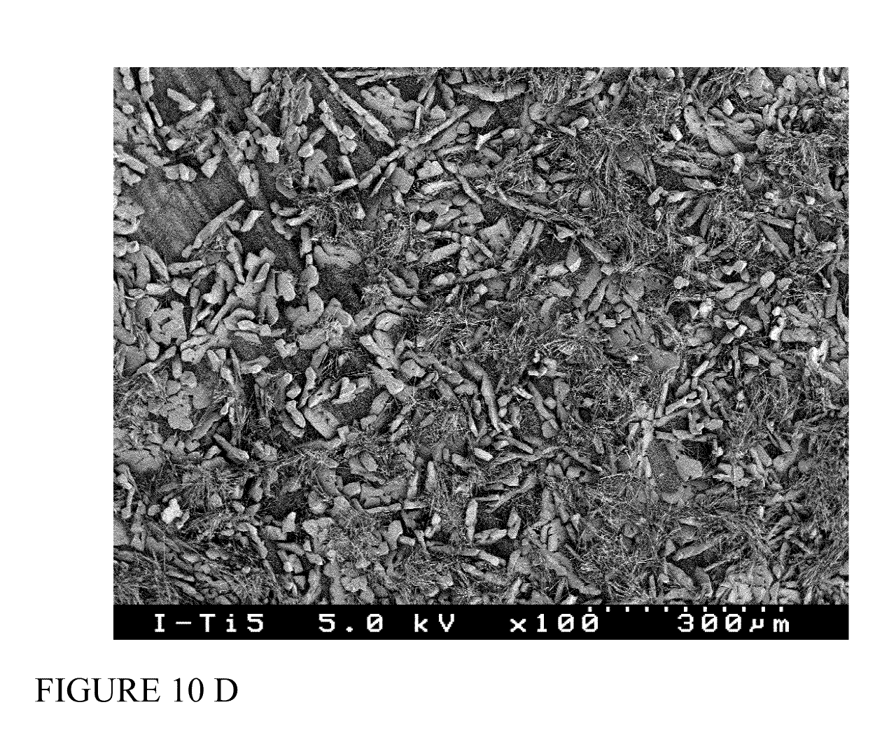

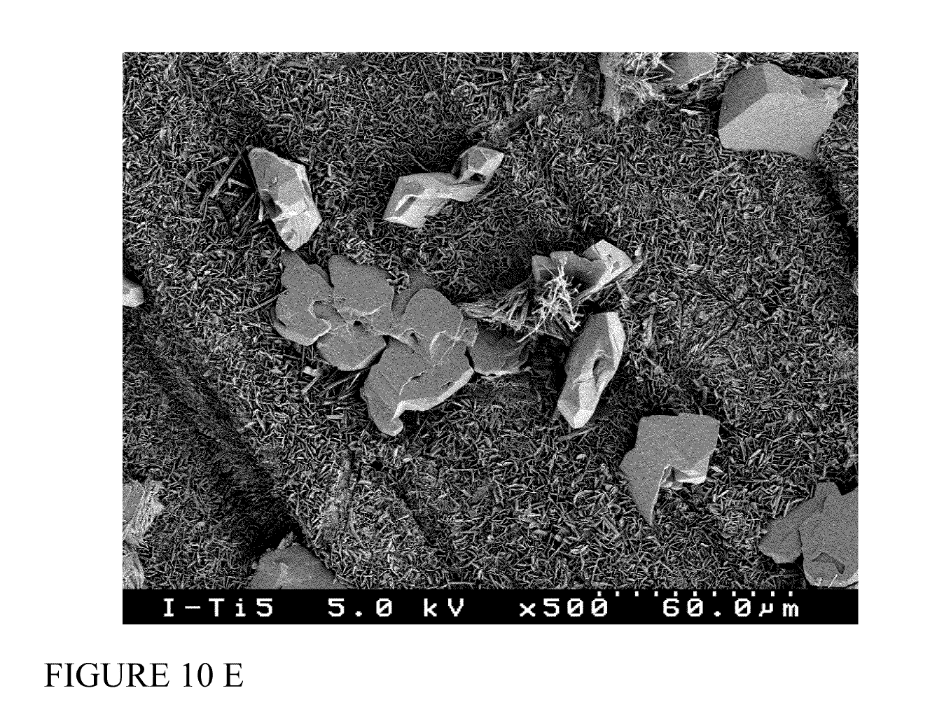

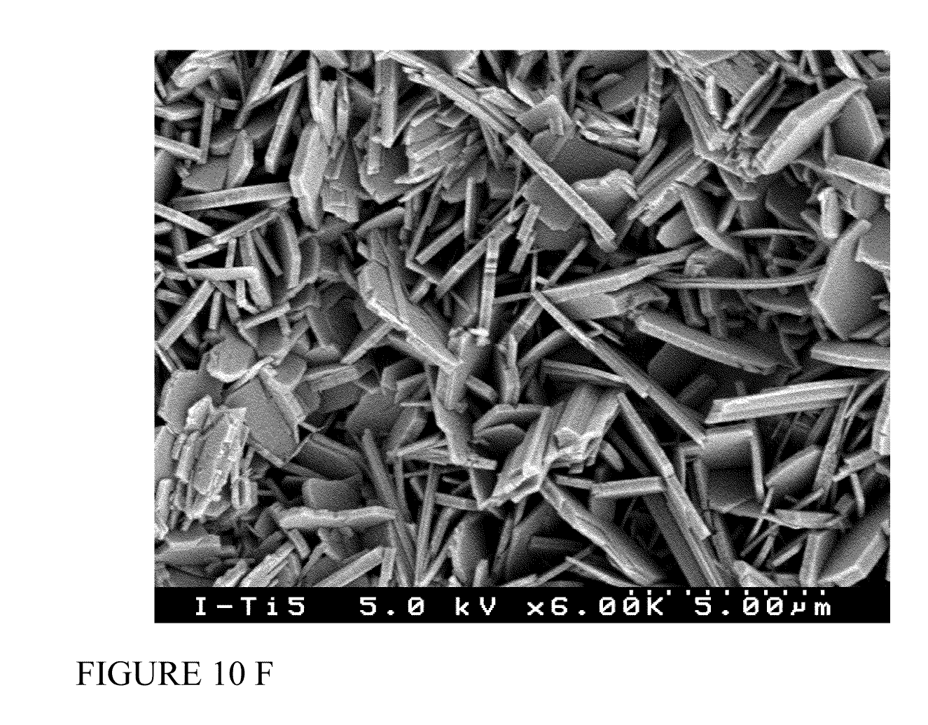

A wide variety of microstructures of the α-Al₂O₃-based coatings were obtained in accordance with several aspects of the present invention, as shown in Tables II A-D. Coatings consisting of equiaxed α-Al₂O₃ crystals of various sizes (See FIGS. 4A-4D and FIGS. 6A-6F), as well as elongated, lath-like, and/or plate-like (FIGS. 6A-6F and FIGS. 10A-10F) were obtained depending upon the deposition conditions and substrate used. The surface coverage by the films could be either continuous, like in FIGS. 4A-4B and FIGS. 6A-6F, or partial (see FIGS. 4C and 4D). Some of the films in the present invention formed dense smooth microstructures; some others formed rough and/or porous coatings (see FIG. 10).

### Chemical and Phase Compositions of the α-Al₂O₃-Based Coatings

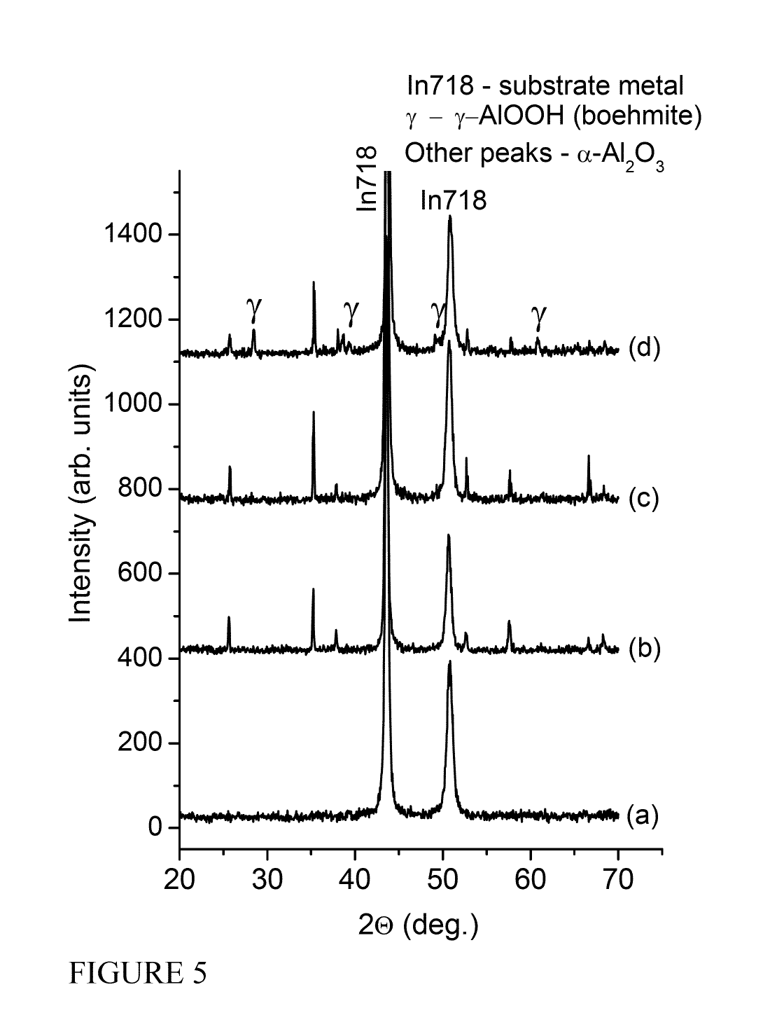

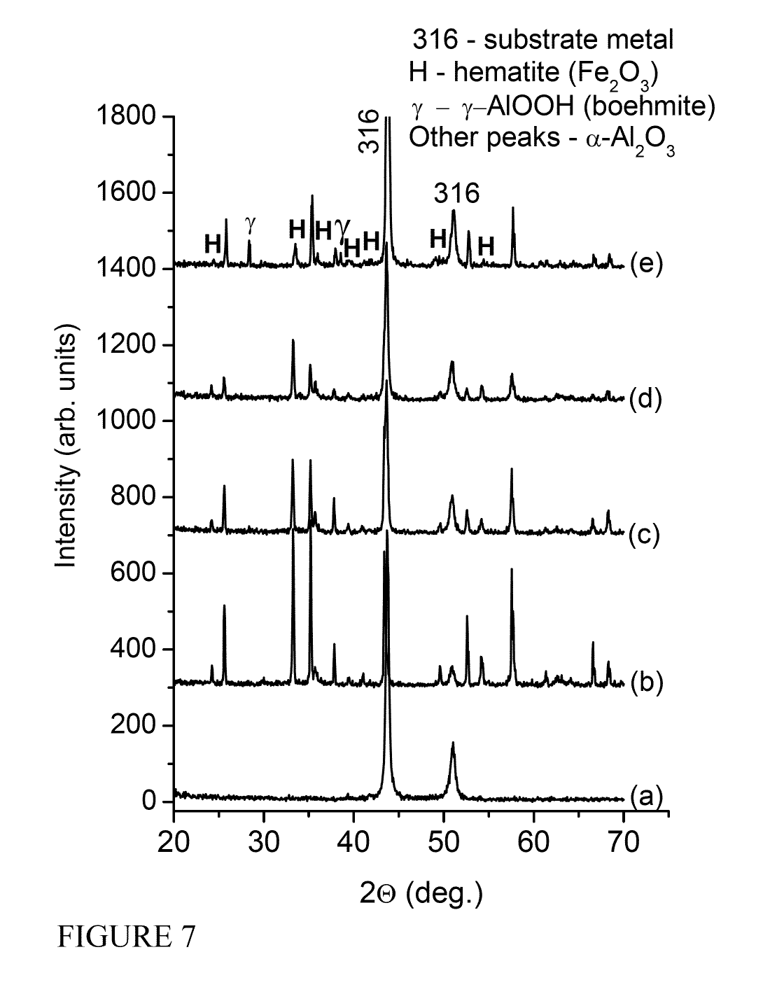

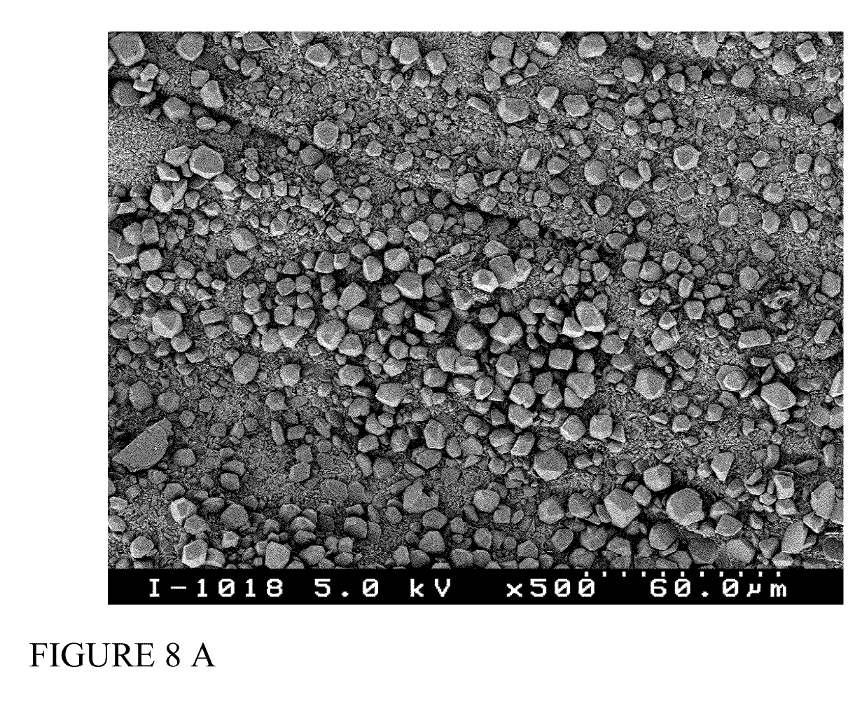

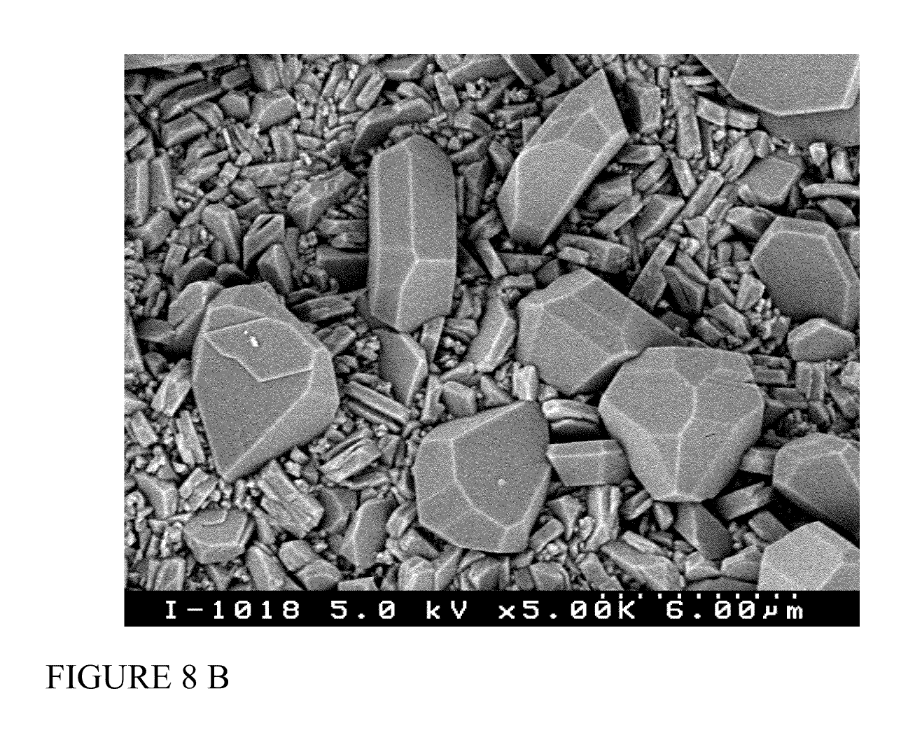

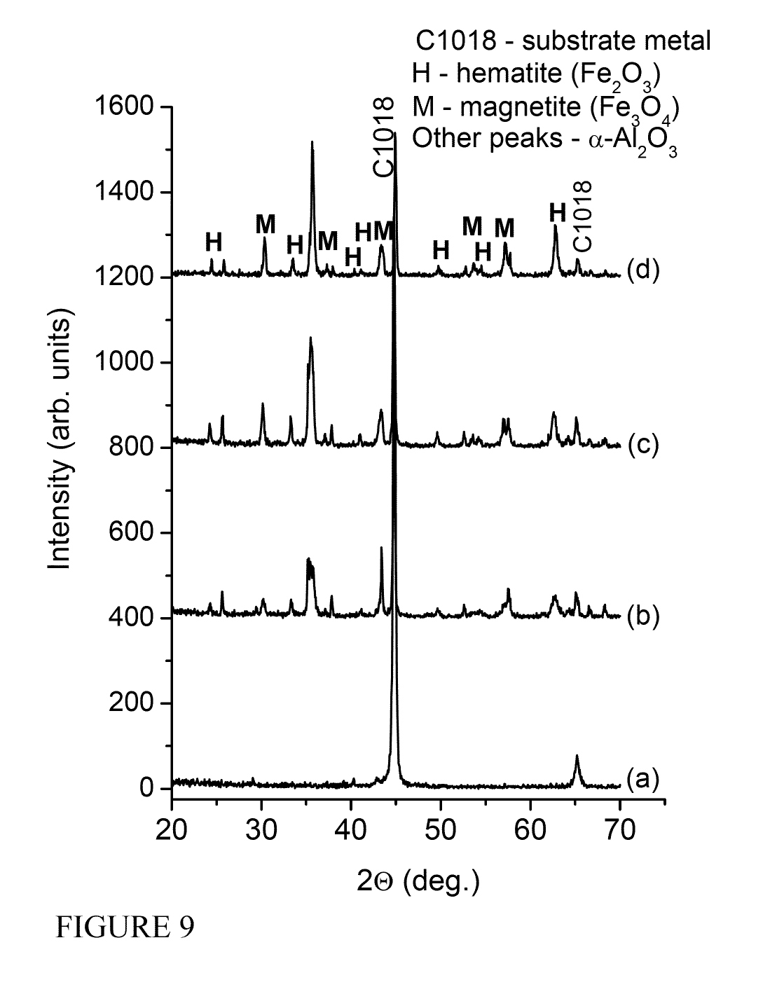

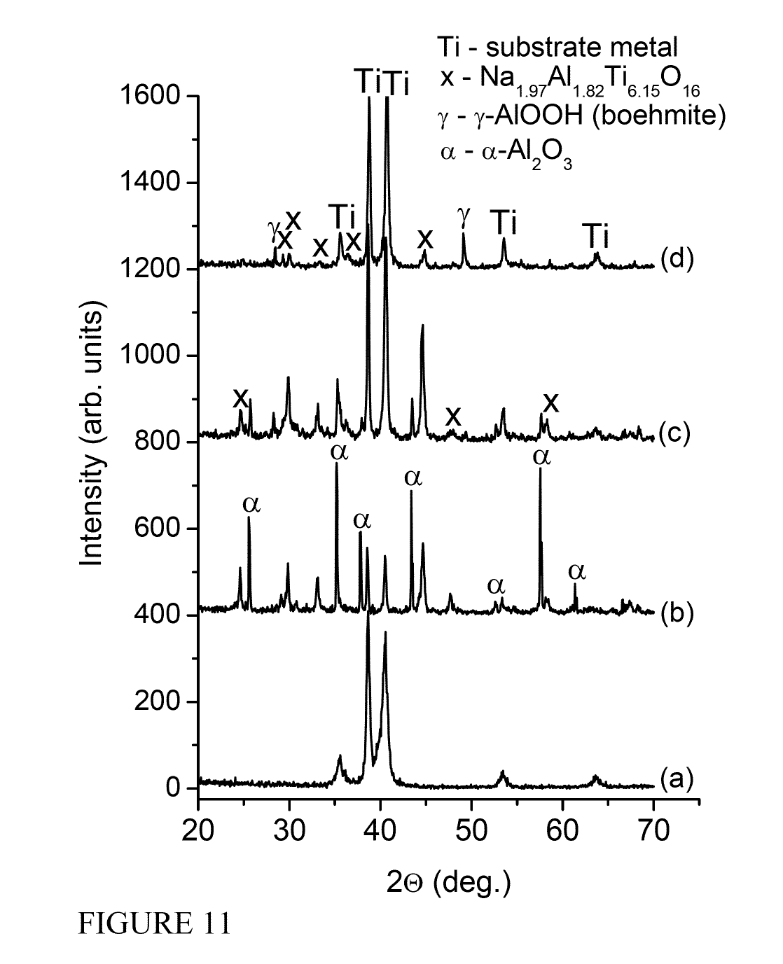

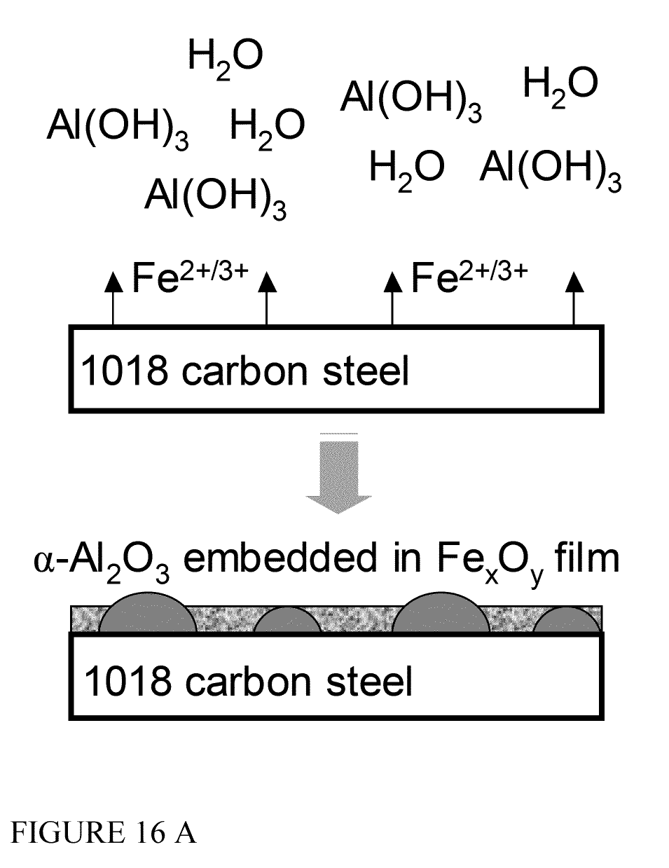

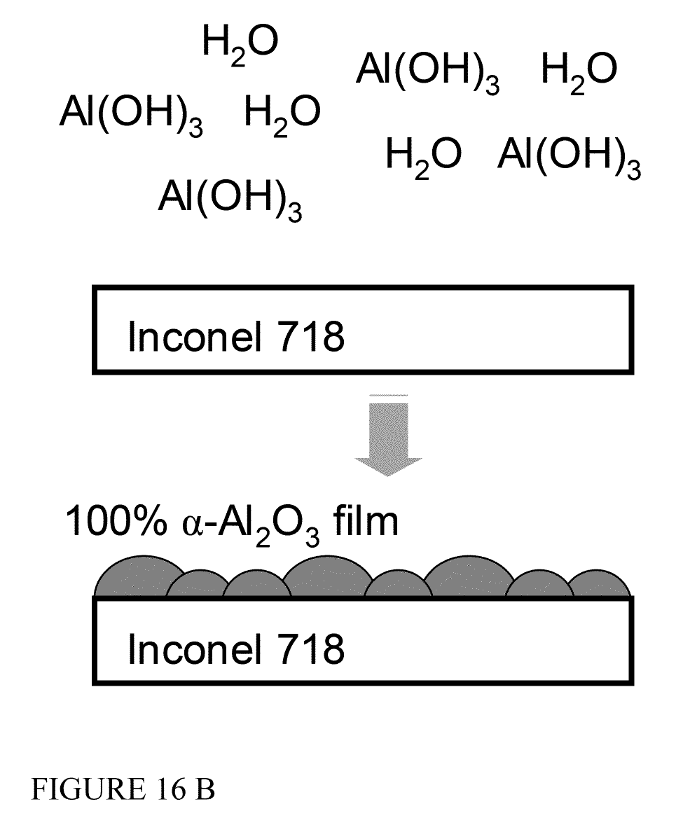

The coatings in accordance with the various aspects of the present invention were either single-phase α-Al₂O₃, like these shown in FIGS. 4A, 4B and FIG. 5b-c, or consisted of other phases, typically in addition to the α-Al₂O₃ phase (see Tables II A-D and FIGS. 5d, 7, 9, and 11). The non-alumina phases, such as hematite, magnetite, or the titanate phase, were derived from the substrate metal and were formed during the hydrothermal deposition of the α-Al₂O₃ coatings (see FIG. 16). In many cases, the α-Al₂O₃ grains and other metal oxide grains formed a uniform mixed coating (see FIGS. 6C-6F). The α-Al₂O₃ crystals could be also incorporated in the substrate-derived metal oxide matrix (see FIGS. 8A and 8B). These mixed phase coatings, which may not be obtained by other synthesis methods, could exhibit unique mechanical, chemical, and electric properties. Thus the present invention encompasses the entire range of hydrothermally synthesized α-Al₂O₃-based coatings, from 100% phase pure α-Al₂O₃ coatings to composite coatings, where the α-Al₂O₃ phase is only trace constituent, with all possible compositions in-between.

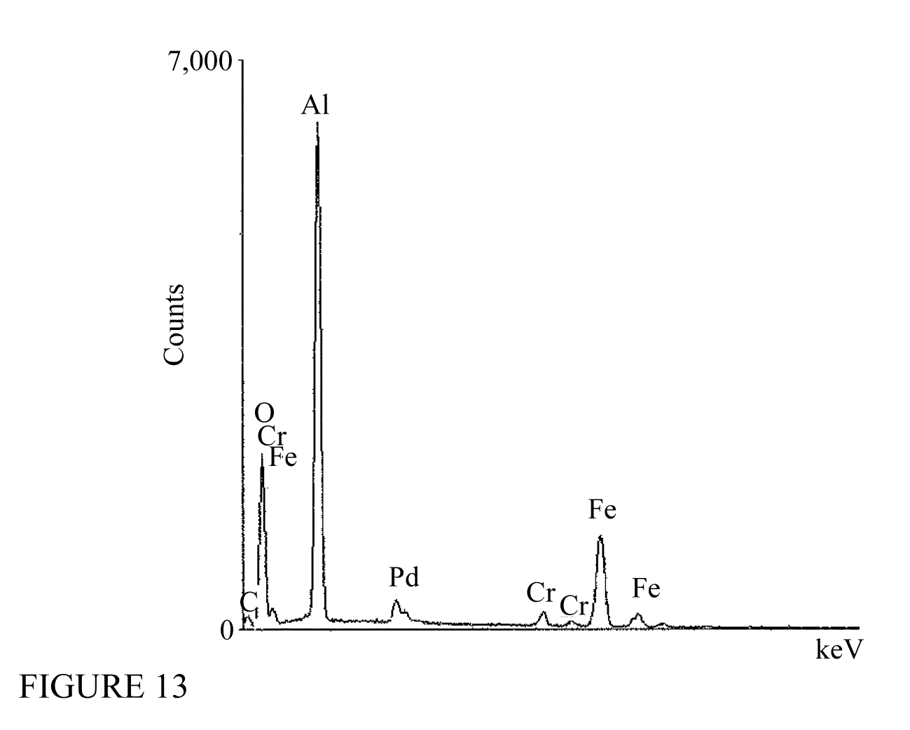

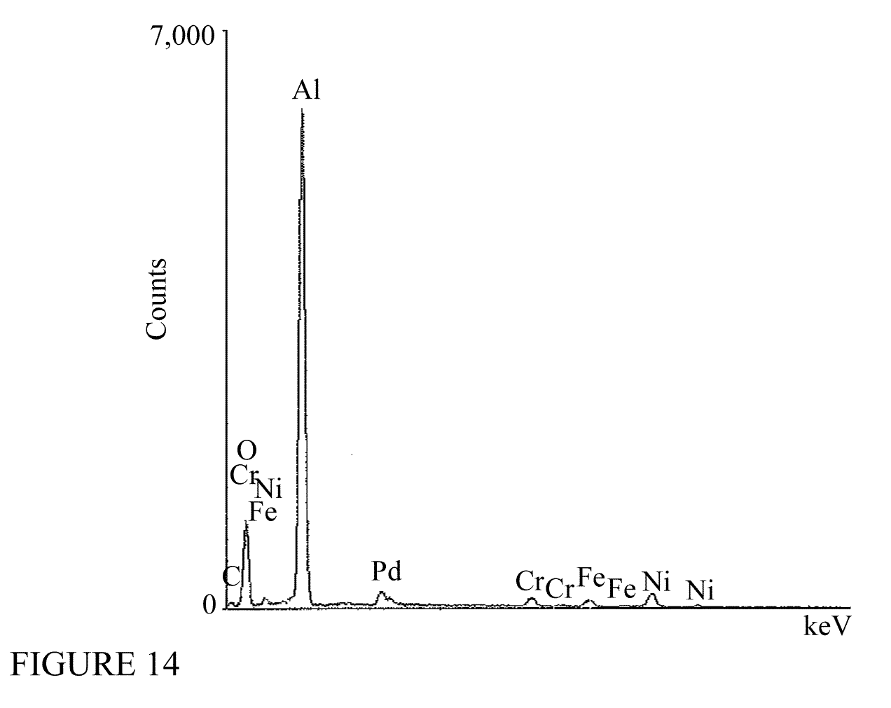

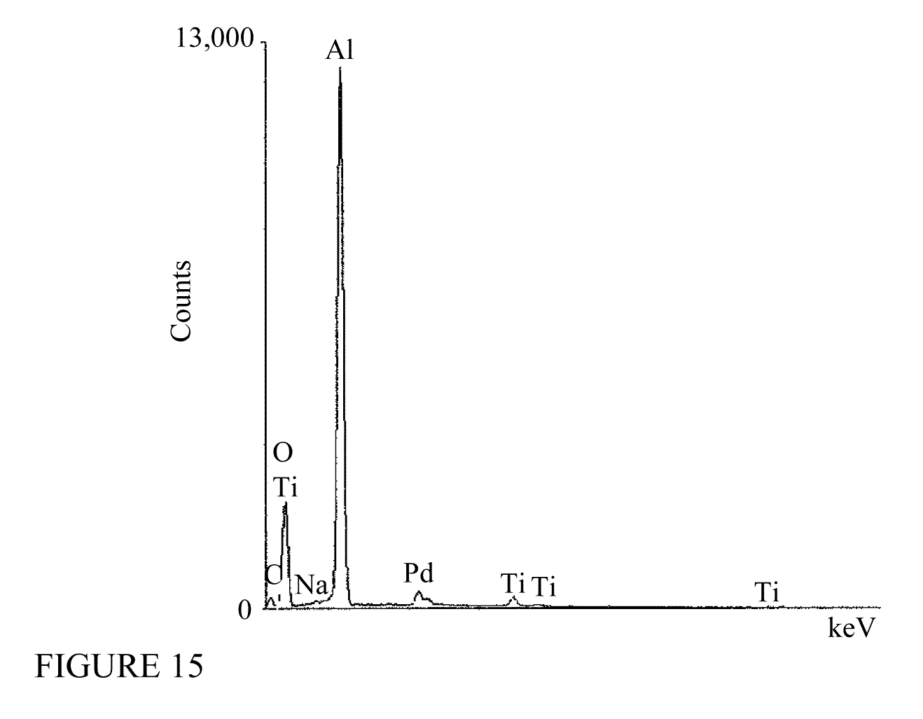

Chemical composition of selected coatings in the present invention suggests the presence of substrate metal-derived atoms even in the α-Al₂O₃ grains. XEDS analysis suggests the presence of Fe, Cr, Ni and/or Ti in α-Al₂O₃ grains deposited on steel, Inconel or titanium substrates (see FIGS. 13-15).

At the low film deposition temperatures, the diffusion coefficients are insufficient to dope the α-Al₂O₃ phase via the bulk diffusion mechanism. Thus the most likely mechanism is incorporation of the ions dissolved from the substrate in the growing film. This in-situ doping is unique for the hydrothermal deposition conditions of the films in the present invention and may result in unique film properties. Again, this effect can be controlled by changing the deposition conditions and either high-purity α-Al₂O₃ coatings or doped α-Al₂O₃ coatings can be synthesized hydrothermally by the methodology described in the present invention.

### Residual Stresses in the α-Al₂O₃-Based Coatings

The residual stresses of two selected α-Al₂O₃-based coatings in accordance with various aspects of the present invention on Inconel 718 and stainless steel 316L were measured and it was found that the in-plane stress distribution was very uniform and narrow and the residual thermal stresses averaged around 1.8-2.0 GPa (see FIGS. 12A and 12B). These are relatively low stresses attributed to the low temperature of film deposition around 400° C. In typical α-Al₂O₃, coatings deposited at higher temperature (around 1,000° C.), the stresses can be over 3 GPa up to 7 GPa, which is detrimental to the mechanical stability of the coatings. Thus the hydrothermal synthesis in accordance with aspects of the present invention produces superior films to the other high temperature methods, without using any template layers.

### Effects of the Substrate Metal

One factor in the hydrothermal deposition process of the α-Al₂O₃ coatings in accordance with an aspect of the present invention was the type of the substrate. FIGS. 4A-4D, 5, 6A-6F, 7, 8A-8b, 9, 10A-10F and 11 show typical microstructures and XRD patterns of various α-Al₂O₃ coatings grown on Inconel 718, stainless steel 316L, carbon steel 1018, and titanium grade 5, respectively. The data presented in the Figures, as well as in Tables II A-D, is self-explanatory. All properties of the α-Al₂O₃ coatings are strong functions of the substrate metal used. Thus the hydrothermal process of this invention has to be tailored individually to each particular substrate to be coated. Alternately, various metal substrates can be used to synthesize α-Al₂O₃ coatings with different properties.

Interactions between the substrate and the deposited α-Al₂O₃ films include reactive substrate, inert substrate and a combination of both. The reactive substrate releases metal ions into the surrounding solution. The ions can subsequently form metal oxide coating, which will be mixed with the α-Al₂O₃ crystals producing α-Al₂O₃-based composite coatings (FIG. 16A). Non-reactive (inert) substrate does not chemically interact with the surrounding aqueous solution, which results in the formation of phase-pure α-Al₂O₃ coatings (FIG. 16B). There combination of both mechanisms produces phase-pure α-Al₂O₃ films in which the ions dissolved from the substrate were incorporated as dopants.

### Effects of the Precursors

Aluminum tri-hydroxide (trihydrate) powders (gibbsite or hydrargillite, chemical formula Al(OH)₃) or aluminum oxide-hydroxide powders (boehmite, chemical formula γ-AlOOH) can be used as precursor powders in hydrothermal synthesis of α-Al₂O₃ coatings in the present invention. During the course of this work, several precursors were tested, however the best results, which provided the highest chemical purity and most consistent and reproducible morphological features of the α-Al₂O₃ powders, were obtained using the following precursors: Type A and Type B, which both are various types of Al(OH)₃. Available typical properties of the precursor powders are summarized in Table I.

### Effects of the Seeds

Seeds can be advantageously used to control the size, composition and rate of crystallization of oxides under hydrothermal conditions See for example U.S. application Publication No. 2007/0280877. The α-Al₂O₃ seeds, mixed with the precursor powder were found to be effective modifiers of microstructure of the synthesized α-Al₂O₃ coatings in the present invention. Seeds having a wide range of median particle sizes between 100 nm and 40 μm can be used. The seeds could be hydrothermally synthesized α-Al₂O₃ powders, either milled or as-synthesized (aggregated), or suitable commercially available α-Al₂O₃ powders. The relationship between the α-Al₂O₃ seeds used as starting materials and the final α-Al₂O₃ hydrothermal products is a complex function of seed quantity (weight/volume fraction of seeds with respect to the precursor powder), particle size, aggregation level, and type of seeds, as well as type of precursor, conditions of hydrothermal synthesis of the α-Al₂O₃ coatings, and method of mixing the seeds with the precursor. This complex relationship has to be established experimentally in each case. Nevertheless, some general observations were made in this work. The smaller the α-Al₂O₃ seeds, the finer the microstructures of the hydrothermally synthesized α-Al₂O₃ coatings of the present invention (see Table II).

### Formation of α-Al₂O₃/γ-AlOOH (Boehmite) Mixed Coatings

During the hydrothermal synthesis, the conversion of the precursor into α-Al₂O₃ can be complete or limited. Several factors, such as lower temperature, shorter synthesis time, conditions of the temperature ramp(s) in hydrothermal treatment, etc. (see for example U.S. application Publication No. 2007/0280877) can be used to make unique composite α-Al₂O₃/γ-AlOOH coatings. In at least one aspect of the present invention, the α-Al₂O₃/γ-AlOOH coatings could be deposited on titanium, Inconel 718, and 316L stainless steel (Examples 3, 7, and 13). Presence of boehmite can result in unique properties of the α-Al₂O₃-based coatings, moreover the boehmite phase could be converted into transition aluminas upon subsequent heat treatment in air, resulting in composite α-Al₂O₃/transition alumina coatings.

### Synthesis of Doped α-Al₂O₃ Coatings

α-Al₂O₃ phase can be doped with a variety of elements during the hydrothermal synthesis, such as Mn or Cr. The doping additives can be selected for specific applications and/or creating unique defect structures. Preferred sources of doping additives can be water-soluble salts of the doping elements, but they can also be derived from dissolved components of metal substrates during the hydrothermal synthesis. It is presumed that any type of salts can be used, providing that they do not introduce unwanted impurities, which could change properties of the α-Al₂O₃. Use of CrCl₃ or KMnO₄ in order to introduce doping elements of Cr and Mn in concentrations of 0.01%, and 0.05%, respectively, is not expected to introduce any modifications to the coatings microstructure (see for example U.S. application Publication No. 2007/0280877). In some cases, however, doping can be used to modify properties of the α-Al₂O₃ (chemical composition, microstructure, etc.).

### Conditions of the Hydrothermal Synthesis

The following reactions take place under hydrothermal conditions to make α-Al₂O₃ powders from alumina hydrates (see FIGS. 2A and 2B):

Al(OH)₃→γ-AlOOH(boehmite)+H₂O (1)

2AlOOH→α-Al₂O₃(corundum)+H₂O (2)

Reaction (1) can occur above ≈100° C. practically independently of the water vapor pressure. Reaction (2) can occur above ≈350° C., but up to ≈450° C. only at pressures not exceeding ≈15 MPa (≈2,200 psi), because of the presence of AlOOH (diaspore)-stability region, which extends from 270° C. to 450° C. and from ≈15 MPa to over 100 MPa. In addition to raw materials and reactor design, very specific time, temperature and pressure “ramps” are required to produce α-Al₂O₃ of the desired characteristics. Due to constraints imposed by the strength of the autoclave, conducting synthesis above 450° C. at high pressure does not seem to be practical. Therefore, at α-Al₂O₃ synthesis temperatures below 450° C. (practical range is 380-430° C.), the pressure is reduced to or below ≈15 MPa (≈2,200 psi). In order to achieve this objective, water vapor pressure is released simultaneously with increasing temperature in the autoclave.

Effects of various possible conditions of the hydrothermal synthesis of α-Al₂O₃ powders have been studied in great detail and described elsewhere. It is believed that growth mechanisms and relationships found in that previous study are of general nature and can be also applied to the hydrothermal synthesis of α-Al₂O₃ coatings/films provided in accordance with aspects of the present invention. This relates not only to the use of dopants but also acidic synthesis conditions (for example use of diluted H₂SO₄), etc.

### CONCLUSION

The present invention provides many aspects. Some example aspects are as follows, however it is to be appreciated that the present invention need not be so limited to the following examples.

A process to deposit an Alpha Alumina (α-Al₂O₃) crystalline coating on a substrate surface, wherein the process includes hydrothermal synthesis of the α-Al₂O₃ crystalline coating. The process may include utilizing an elevated temperature within the range of about 380° C.-430° C. for a time duration of within the range of about 1-10 days. The process may include utilizing a precursor having approximately 65% Al₂O₃, approximately 0.1-0.35% Na₂O of which a maximum of 0.17% is soluble, approximately 0.007-0.01% Fe₂O₃, approximately 0.001-0.005% SiO₂, 0.02-0.05% Free Moisture, a Specific Gravity of approximately 2.42 (g/cm³), and a Refractive Index of approximately 1.57. The process may provide the coating as an essentially pure α-Al₂O₃ crystalline coating. The substrate may be a metal in the process. The process may include some amount of dissolution of the metal substrate during the hydrothermal process and the process may provide the coating to include metal oxide. The metal oxide may be within the range of below 90%.

Dopants may be dissolved from the substrate during the hydrothermal process and incorporated into the coating. The process may include utilizing a precursor that includes dopants that are dissolved from the precursor during the hydrothermal process and incorporated into the coating. The process may provide the coating to contain boehmite. The boehmite may be within the range of below 90%. At least one of grain size, thickness and porosity may be controlled during the hydrothermal process by controlling at least one of temperature cycle, seeds and precursor selection. The process may include the use of acidic media to control submicron/nano particle size. The process may include the use of acidic aluminum salts to control submicron/nano particle size. At least one morphology of being equiaxed, elongated or platelets may be controlled during the hydrothermal process. The coating may include α-Al₂O₃ particles within the range of approximately 2 nm-1000 microns. The coating may include α-Al₂O₃ particles within the range of approximately 10 nm-40 microns.

The substrate may be one of a metal, ceramic and plastic. The substrate may be at least one of porous and fibrous. The substrate may be particulate. The substrate may be nano sized. The provided coating may have a strong resistance against release from the substrate. The provided coating may be porous.

Of course, the process provides an α-Al₂O₃ coating. An apparatus is used to deposit the α-Al₂O₃ coating and is used in conjunction with the process. The apparatus may include an autoclave and a heat exchanger. The apparatus may provide varied coatings in a single hydrothermal heating cycle by using separate liners.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims

What is claimed:

1. A process to deposit an Alpha Alumina (α-Al₂O₃) crystalline coating on a substrate surface, wherein the process includes hydrothermal synthesis of the α-Al₂O₃ crystalline coating.

2. A process as set forth in claim 1, wherein the process includes utilizing an elevated temperature within the range of about 380° C.-430° C. for a time duration of within the range of about 1-10 days.

3. A process as set forth in claim 1, wherein the process includes utilizing a precursor having approximately 65% Al₂O₃, approximately 0.1-0.35% Na₂O of which a maximum of 0.17% is soluble, approximately 0.007-0.01% Fe₂O₃, approximately 0.001-0.005% SiO₂, 0.02-0.05% Free Moisture, a Specific Gravity of approximately 2.42 (g/cm³), and a Refractive Index of approximately 1.57.

4. A process as set forth in claim 1, wherein the process provides the coating as an essentially pure α-Al₂O₃ crystalline coating.

5. A process as set forth in claim 1, wherein the substrate is a metal, the process includes some amount of dissolution of the metal substrate during the hydrothermal process and the process provides the coating to include metal oxide.

6. A process as set forth in claim 5, wherein the metal oxide is within the range of below 90%.

7. A process as set forth in claim 1, wherein dopants are dissolved from the substrate during the hydrothermal process and incorporated into the coating.

8. A process as set forth in claim 1, wherein the process includes utilizing a precursor that includes dopants that are dissolved from the precursor during the hydrothermal process and incorporated into the coating.

9. A process as set forth in claim 1, wherein the process provides the coating to contain boehmite.

10. A process as set forth in claim 5, wherein the boehmite is within the range of below 90%.

11. A process as set forth in claim 1, wherein at least one of grain size, thickness and porosity is controlled during the hydrothermal process by controlling at least one of temperature cycle, seeds and precursor selection.

12. A process as set forth in claim 1, wherein the process includes the use of acidic media to control submicron/nano particle size.

13. A process as set forth in claim 1, wherein the process includes the use of acidic aluminum salts to control submicron/nano particle size.

14. A process as set forth in claim 1, wherein at least one morphology of being equiaxed, elongated or platelets is controlled during the hydrothermal process.

15. A process as set forth in claim 1, wherein coating includes α-Al₂O₃ particles within the range of approximately 2 nm-1000 microns.

16. A process as set forth in claim 15, wherein coating includes α-Al₂O₃ particles within the range of approximately 10 nm-40 microns.

17. A process as set forth in claim 1, wherein the substrate is one of a metal, ceramic and plastic.

18. A process as set forth in claim 1, wherein the substrate is at least one of porous and fibrous.

19. A process as set forth in claim 1, wherein the substrate is particulate.

20. A process as set forth in claim 1, wherein the substrate is nano sized.

21. A process as set forth in claim 1, wherein the provided coating has a strong resistance against release from the substrate.

22. A process as set forth in claim 1, wherein the provided coating is porous.

23. An α-Al₂O₃ coating deposited by the process of claim 1.

24. An apparatus used to deposit the α-Al₂O₃ coating as set forth in claim 1.

25. An apparatus as set forth in claim 24, wherein the apparatus includes an autoclave and a heat exchanger.

26. An apparatus as set forth in claim 24, wherein the apparatus provides varied coatings in a single hydrothermal heating cycle by using separate liners.
